(19) United States
(12) Patent Application Publication
(10) Pub. No.: US 2019/0073113 A1
(43) Pub. Date: Mar. 7, 2019

(54) Method and Terminal for Displaying Notification Message and Non-transitory Computer-readable Storage Medium

(71) Applicant: GUANGDONG OPPO MOBILE TELECOMMUNICATIONS CORP., LTD., Dongguan (CN)

(72) Inventor: Song YANG, Dongguan (CN)

(73) Assignee: GUANGDONG OPPO MOBILE TELECOMMUNICATIONS CORP., LTD., Dongguan (CN)

(21) Appl. No.: 16/115,383

(22) Filed: Aug. 28, 2018

(30) Foreign Application Priority Data
Sep. 5, 2017 (CN) 201710791790.3

(51) Int. Cl. G06F 3/0481; G06F 3/0488; G06F 3/0484

(52) U.S. Cl. CPC G06F 3/04817; G06F 3/04847; G06F 3/0488

(57) ABSTRACT

Provided are a method and terminal for displaying a notification message, and a non-transitory computer-readable storage medium. The method includes that: application icons of multiple preset applications are displayed in an auxiliary display region of a terminal; when a notification message is acquired, a target application corresponding to the notification message is determined; and when the multiple preset applications comprise the target application, the notification message and an operation option are displayed in the auxiliary display region, the auxiliary display region being a region which is different from a main display region of the terminal, the main display region being configured to display an interface of a present running task of the terminal.

### CROSS-REFERENCE TO RELATED APPLICATIONS

This application claims priority to Chinese Patent Application No. 201710791790.3, filed Sep. 5, 2017, entitled “Method and Device for displaying Notification Message”. The above identified application is hereby incorporated herein by reference in its entirety.

### TECHNICAL FIELD

The disclosure relates to the technical field of terminals, and particularly to a method and terminal for displaying a notification message, and a non-transitory computer-readable storage medium.

### BACKGROUND

Along with development of a terminal technology, a load capacity of a terminal becomes increasingly high, and various applications may be installed on the terminal, for example, information interaction type applications like WeChat, short message service and telephone service and other applications like Taobao, Baidu and MicroBlog. In processes of running these applications, the terminal may usually receive notification messages of these applications, for example, a chat message from a friend of WeChat, an incoming call message of the telephone service, a delivery message for an order of Taobao and a hotspot pushing message of MicroBlog.

At present, when a notification message of any application is received, a terminal may display the notification message in a specified region on a screen, the specified region is a part of region of a terminal task interface, and the terminal task interface is a display interface, for execution of a present task, of the terminal, for example, a chat interface of WeChat.

In a process of implementing the disclosure, the inventor finds that a conventional art at least has the following problem.

In the art, when a notification message of any application is received, a terminal may display the notification message on a screen, so that a part of region of a terminal task interface may be covered and certain interference may be brought to a present task.

### SUMMARY

Embodiments of the disclosure provide a method and terminal for displaying a notification message, and a non-transitory computer-readable storage medium.

In at least one alternative embodiment, a method for displaying a notification message is provided, including: displaying application icons of multiple preset applications in an auxiliary display region of a terminal; when a notification message is acquired, determining a target application corresponding to the notification message; and when the multiple preset applications comprise the target application, displaying the notification message and an operation option in the auxiliary display region, the auxiliary display region being a region which is different from a main display region of the terminal, the main display region being configured to display an interface of a present running task of the terminal.

In at least one alternative embodiment, a terminal for displaying a notification message is provided, including: at least one processor; and a computer readable storage, coupled to the at least one processor and storing at least one computer executable instructions thereon, which when the at least one computer executable instructions is executed by the at least one processor, cause the at least one processor to carry out following actions: displaying application icons of multiple preset applications in an auxiliary display region of the terminal; when a notification message is obtained, determining a target application corresponding to the notification message; and when the multiple preset applications comprise the target application, displaying the notification message and an operation option in the auxiliary display region, the auxiliary display region being a region which is different from a main display region, the main display region being configured to display an interface of a present running task of the terminal.

In at least one alternative embodiment, a non-transitory computer-readable storage medium is provided, on which a computer program is stored, wherein the computer program is executed by a processor to carry out following actions: obtaining a notification message; and displaying the notification message and an operation option in an auxiliary display region of a terminal, the auxiliary display region being a region which is different from a main display region of the terminal, the main display region being configured to display an interface of a present running task of the terminal.

### BRIEF DESCRIPTION OF THE DRAWINGS

In order to describe the technical solutions in the embodiments of the disclosure more clearly, the drawings required to be used in descriptions about the embodiments will be simply introduced below. Obviously, the drawings in the following descriptions are only some embodiments of the disclosure. Those of ordinary skilled in the art may further obtain other drawings according to these drawings without creative work.

FIG. 1 is a structure block diagram of a terminal 100 according to an embodiment of the disclosure;

FIG. 2 is a structure block diagram of a terminal 100 according to another embodiment of the disclosure;

FIG. 3A is a schematic diagram of a full screen according to an embodiment of the disclosure;

FIG. 3B is a schematic diagram of a curved screen according to an embodiment of the disclosure;

FIG. 3C is a schematic diagram of an irregularly-shaped screen according to an embodiment of the disclosure;

FIG. 3D is a schematic diagram of an irregularly-shaped screen according to another embodiment of the disclosure;

FIG. 3E is a schematic diagram of an irregularly-shaped screen according to another embodiment of the disclosure;

FIG. 3F is a schematic diagram of an irregularly-shaped screen according to another embodiment of the disclosure;

FIG. 4 is a schematic diagram of display regions of a terminal according to an embodiment of the disclosure;

FIG. 5 is a flowchart of a method for displaying a notification message according to an embodiment of the disclosure;

FIG. 6 is a flowchart of a notification message display method according to another embodiment of the disclosure;

FIG. 7 is a schematic diagram of application icons of multiple preset applications in an auxiliary display region according to an embodiment of the disclosure;

FIG. 8 is a schematic diagram of application icons of multiple preset applications in an auxiliary display region according to another embodiment of the disclosure;

FIG. 9 is a schematic diagram of displaying a notification message and an operation option according to an embodiment of the disclosure;

FIG. 10 is a schematic diagram of application icons of multiple preset applications in an auxiliary display region according to an embodiment of the disclosure;

FIG. 11 is a schematic diagram of displaying a notification message and an operation option according to an embodiment of the disclosure;

FIG. 12 is a schematic diagram of application icons of multiple preset applications in an auxiliary display region according to an embodiment of the disclosure;

FIG. 13 is a schematic diagram of application icons of multiple preset applications in an auxiliary display region according to another embodiment of the disclosure;

FIG. 14 is a schematic diagram of displaying a notification message and an operation option according to an embodiment of the disclosure;

FIG. 15 is a schematic diagram of displaying a notification message and an operation option according to another embodiment of the disclosure;

FIG. 16 is a schematic diagram of displaying a notification message and an operation option according to another embodiment of the disclosure;

FIG. 17 is a schematic diagram of displaying a notification message and an operation option according to another embodiment of the disclosure; and

FIG. 18 is a structure diagram of a device for displaying a notification message according to an embodiment of the disclosure.

### DETAILED DESCRIPTION OF THE EMBODIMENTS

In order to make the purpose, technical solutions and advantages of the disclosure clearer, implementation modes of the disclosure will further be described below in combination with the drawings in detail.

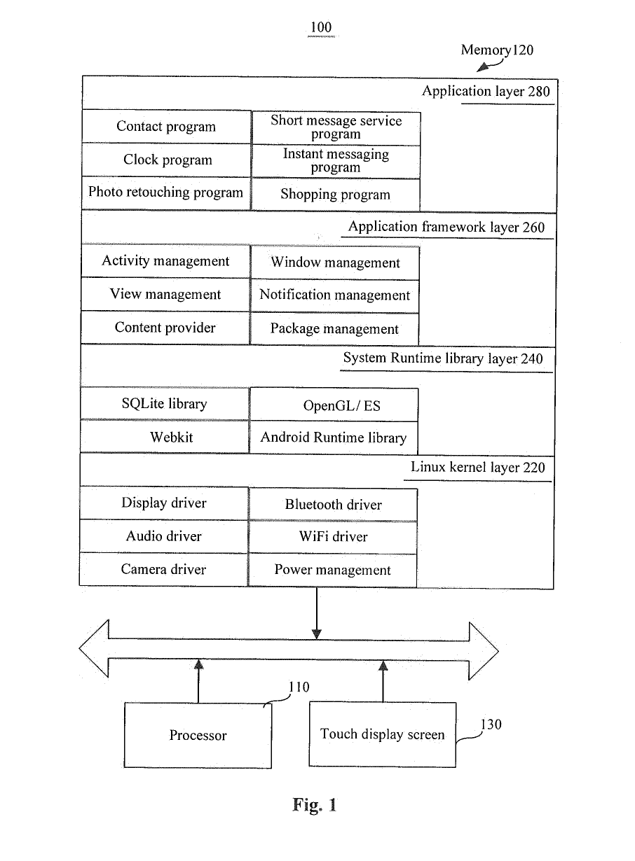

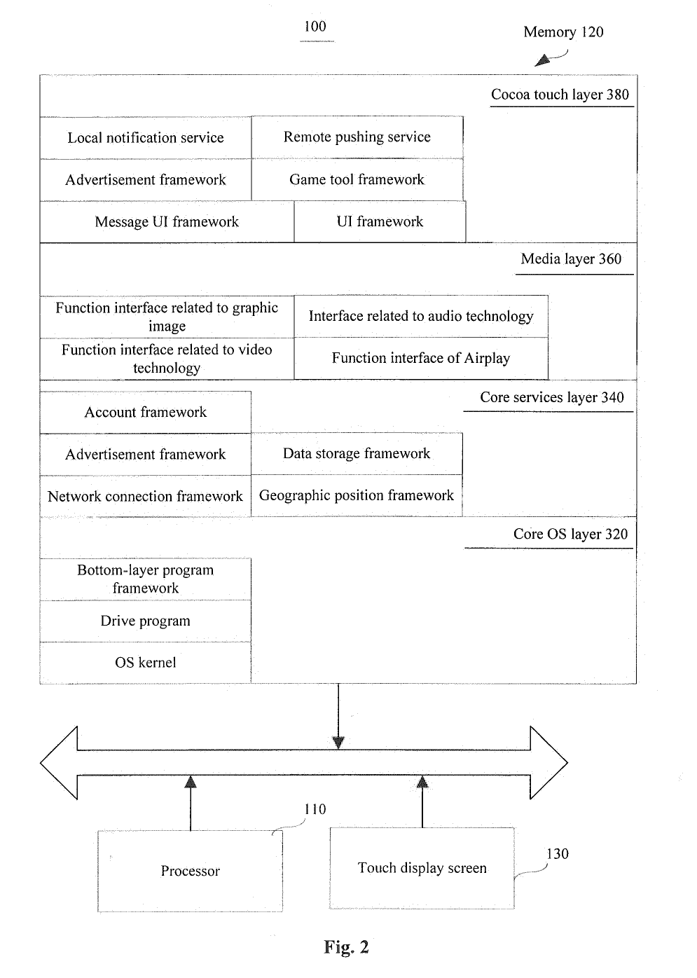

Referring to FIG. 1 and FIG. 2, structure block diagrams of a terminal 100 according to an exemplary embodiment of the disclosure are shown. The terminal 100 may be a mobile phone, a tablet computer, a notebook computer, an electronic book and the like. The terminal 100 in the disclosure may include at least one of the following components: a processor 110, a memory 120 and a touch display screen 130.

The processor 110 may include at least one processing core. The processor 110 connects each part in the whole terminal 100 by virtue of various interfaces and lines, and executes various functions and data processing of the terminal 100 by running or executing an instruction, program, code set or instruction set stored in the memory 120 and calling data stored in the memory 120. Optionally, the processor 110 may be implemented in at least one hardware form of Digital Signal Processing (DSP), a Field-Programmable Gate Array (FPGA) and a Programmable Logic Array (PLA). The processor 110 may integrate one or combination of more of a Central Processing Unit (CPU), a Graphics Processing Unit (GPU), a modem and the like, wherein the CPU mainly processes an Operating System (OS), a User Interface (UI), an application program and the like; the GPU is configured to render and draw a content to be displayed on the touch display screen 130; and the modem is configured to process wireless communication. It can be understood that the modem may also not be integrated into the processor 110 but be independently implemented by a chip.

The memory 120 may include a Random Access Memory (RAM) and may also include a Read-Only Memory (ROM). Optionally, the memory 120 includes a non-transitory computer-readable storage medium. The memory 120 may be configured to store the instruction, the program, a code, the code set or the instruction set. The memory 120 may include a program storage region and a data storage region, wherein the program storage region may store an instruction configured to implement the OS, an instruction configured for at least one function (for example, a touch function, a sound playing function and an image playing function), an instruction configured to implement each of the following method embodiments and the like; and the data storage region may store data (for example, audio data and a phonebook) created according to use of the terminal 100 and the like.

For example, the OS is an Android system. The program and data stored in the memory 120 are shown in FIG. 1. A Linux kernel layer 220, a system Runtime library layer 240, an application framework layer 260 and an application layer 280 are stored in the memory 120. The Linux kernel layer 220 provides bottom-layer drivers for various types of hardware of the terminal 100, for example, a display driver, an audio driver, a camera driver, a Bluetooth driver, a Wireless Fidelity (Wi-Fi) driver and power management. The system Runtime library layer 240 provides a main feature support for the Android system through some C/C++ libraries. For example, an SQLite library provides a database support, an OpenGL/ES library provides a three-Dimensional (3D) drawing support, and a Webkit library provides a browser kernel support. The system Runtime library layer 240 further provides an Android Runtime library which mainly provides some kernel libraries to allow a developer to compile Android applications by virtue of a Java language. The disclosure framework layer 260 provides various Application Programming Interfaces (APIs) which may be used when application programs are constructed, and the developer may also construct own application programs by virtue of these APIs, for example, activity management, window management, view management, notification management, a content provider, package management, communication management, resource management and positioning management. At least one application program is run in the disclosure layer 280, and these application programs may be a contact program, short message service program, clock program, camera application and the like of the OS and may also be application programs developed by third-party developers, for example, an instant messaging program and a photo retouching program.

For example, the OS is an iPhone Operating System (iOS). The program and data stored in the memory 120 are shown in FIG. 2. The iOS includes: a Core OS layer 320, a Core services layer 340, a Media layer 360 and a Cocoa touch layer 380. The Core OS layer 320 includes an OS kernel, a drive program and bottom-layer program frameworks, and these bottom-layer program frameworks provide functions more approximate to hardware for program frameworks positioned in the Core services layer 340 to use. The Core services layer 340 provides system service and/or program frameworks required by the disclosure programs, for example, a foundation framework, an account framework, an advertisement framework, a data storage framework, a network connection framework, a geographic position framework and a motion framework. The Media layer 360 provides audio and visual interfaces for the disclosure programs, for example, an interface related to a graphic image, an interface related to an audio technology, an interface related to a video technology and an AirPlay interface related to an audio/video transmission technology. The Cocoa touch layer 380 provides frameworks related to various common interfaces for development of the disclosure programs, and the Cocoa touch layer 380 is responsible for a touch interaction operation of a user on the terminal 100, for example, local notification service, remote pushing service, an advertisement framework, a game tool framework, a message UI framework, a UIKit framework and a map framework.

In the frameworks shown in FIG. 2, the frames related to most of the disclosure programs include, but not limited to: the foundation framework in the core services layer 340 and the UIKit framework in the Cocoa touch layer 380. The foundation framework provides many basic object classes and data types, provide most basic system service for all of the disclosure programs and is unrelated to UIs. Classes provided by the UIKit framework are basic UI class libraries and are configured to create touch-based UIs. An iOS application program may provide a UI on the basis of the UIKit framework, so that a basic architecture of the disclosure program is provided to construct the UI to draw and process a user interaction event, a response gesture and the like.

The touch display screen 130 is configured to receive a touch operation executed by the user thereon or nearby by virtue of any proper object such as a finger and a stylus and display the UI of each application program. The touch display screen 130 is usually arranged on a front panel of the terminal 100. The touch display screen 130 may be designed into a full screen, a curved screen or an irregularly-shaped screen. The touch display screen 130 may further be designed into a combination of the full screen and the curved screen and a combination of the irregularly-shaped screen and the curved screen, which will not be limited in the embodiment.

The Full Screen

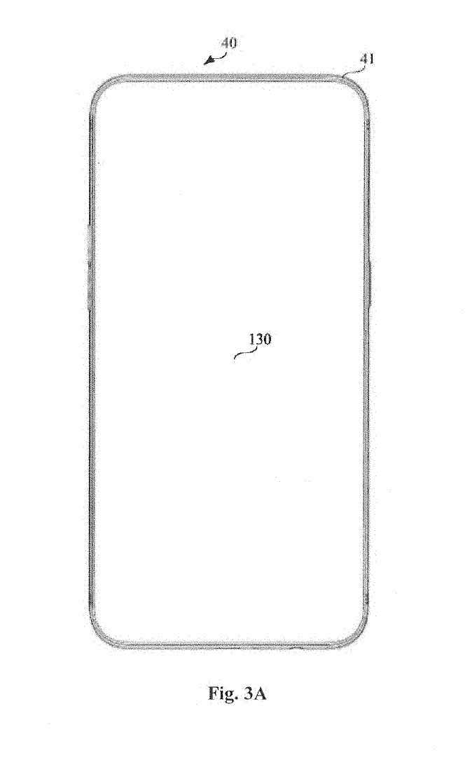

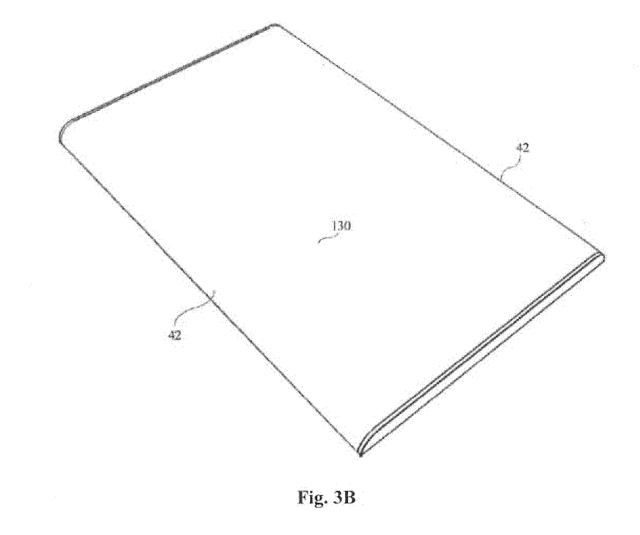

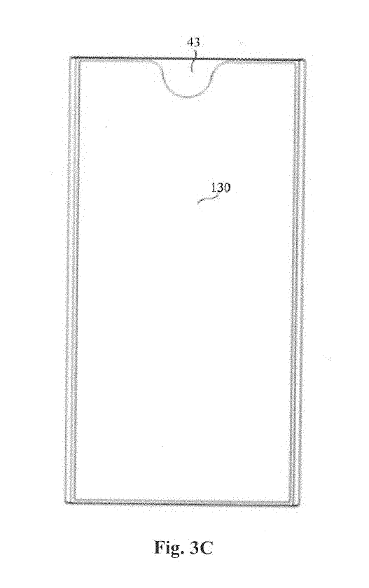

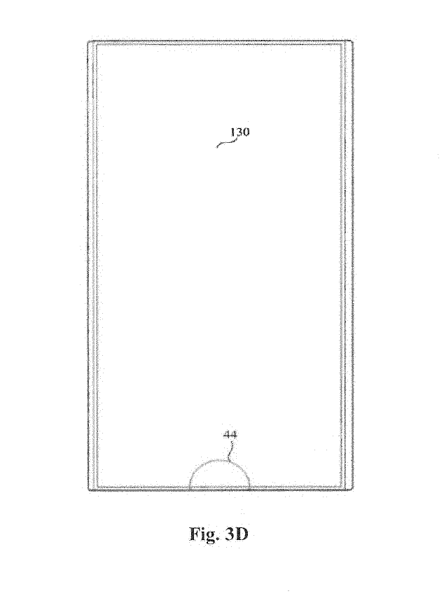

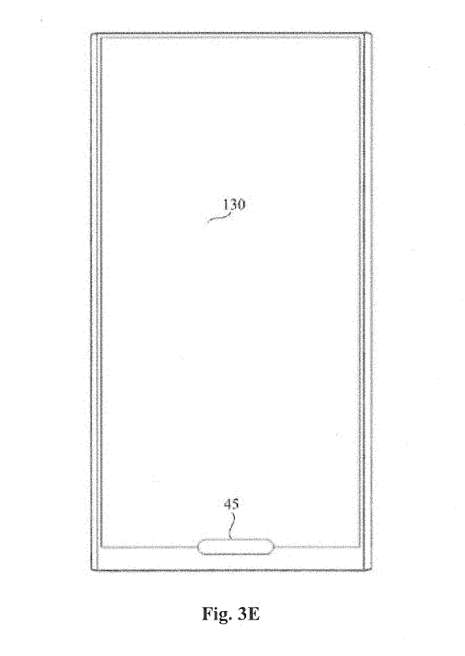

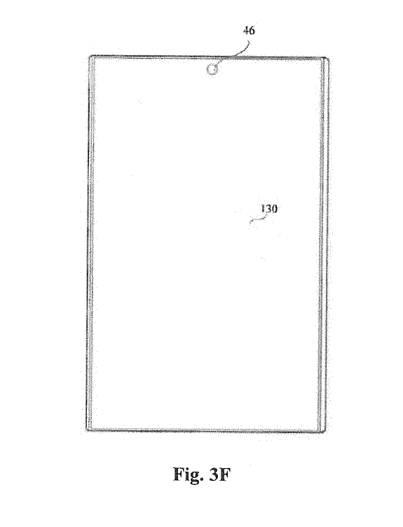

The full screen may refer to such a screen with a design that a screen-to-body ratio of the touch display screen 130 relative to the front panel of the terminal 100 exceeds a threshold value (for example, 80% or 90% or 95%). A calculation manner for the screen-to-body ratio is: (area of the touch display screen 130/area of the front panel of the terminal 100)*100%; another calculation manner for the screen-to-body ratio is: (area of an actual display region in the touch display screen 130/area of the front panel of the terminal 100)*100%; and another calculation manner for the screen-to-body ratio is: (diagonal of the touch display screen 130/diagonal of the front panel of the terminal 100)*100%. In a schematic example shown in FIG. 3A, almost the whole region on the front panel of the terminal 100 is the touch display screen 130, and all of the other region, except an edge formed by a middle frame 41, on the front panel 40 of the terminal 100 is the touch display screen 130. Four angles of the touch display screen 130 may be right angles or rounded angles.

The full screen may also be such a screen with a design that at least one front panel component is integrated to an interior or lower layer of the touch display screen 130. In at least one alternative embodiment, the at least one front panel component includes: a camera, a fingerprint sensor, a proximity light sensor, a distance sensor and the like. In some embodiments, other components on a front panel of a conventional terminal are integrated into the whole region or part of the region of the touch display screen 130. For example, after a light sensing element in the camera is split into multiple light sensing pixels, each light sensing pixel is integrated into a black region of each display pixel in the touch display screen 130. Since the at least one front panel component is integrated to the interior of the touch display screen 130, the full screen has a higher screen-to-body ratio.

Of course, in some other embodiments, the front panel components on the front panel of the conventional terminal may also be arranged on a side edge or back surface of the terminal 100. For example, an ultrasonic fingerprint sensor is arranged below the touch display screen 130, a bone conduction receiver is arranged inner the terminal 130 and the camera is arranged to be a pluggable structure positioned on the side edge of the terminal.

In some optional embodiments, when the terminal 100 adopts the full screen, edge touch sensors 120 are arranged on a single side edge, or two side edges (for example, left and right side edges) or four side edges (for example, upper, lower, left and right side edges) of the middle frame of the terminal 100, and the edge touch sensor 120 is configured to detect at least one operation of a touch operation, clicking operation, pressing operation, sliding operation and the like of the user over the middle frame. The edge touch sensor 120 may be any one of a touch sensor, a thermodynamic sensor, a pressure sensor and the like. The user may apply an operation on the edge touch sensor 120 to control an application program in the terminal 100.

The Curved Screen

The curved screen refers to such a screen with a design that the screen region of the touch display screen 130 is not positioned in the same plane. In general, the curved screen at least has such a section that the section is in a bent shape and a projection of the curved screen in any plane perpendicular to the section is a flat, wherein the bent shape may be a U shape. Optionally, the curved screen refers to such a screen with a design that at least one side edge is in the bent shape. In an alternative embodiment, the curved screen refers to that at least one side edge of the touch display screen 130 extends to and covers the middle frame of the terminal 100. The side edge of the touch display screen 130 extends to and covers the middle frame of the terminal 100, that is, the middle frame originally without a display function and a touch function is covered to form a display region and/or an operating region, so that the curved screen is endowed with a higher screen-to-body ratio. In an alternative embodiment, in an example shown in FIG. 3B, the curved screen refers to such a screen with a design that the left and right side edges 42 are in the bent shape; or, the curved screen refers to such a screen with a design that the upper and lower side edges are in the bent shape; or, the curved screen refers to such a screen with a design that all of the upper, lower, left and right side edges are in the bent shape. In an optional embodiment, the curved screen is prepared from a touch screen material with certain flexibility.

The Irregularly-Shaped Screen

The irregularly-shaped screen is a touch display screen of which an apparent shape is an irregular shape, and the irregular shape is not a rectangle or a rounded rectangle. In an alternative embodiment, the irregularly-shaped screen refers to such a screen with a design that a bump, nick and/or hole are/is arranged on the rectangular or rounded rectangular touch display screen 130. In an alternative embodiment, the bump, the nick and/or the hole may be positioned on an edge, screen center or both of the touch display screen 130. When being arranged on an edge, the bump, the nick and/or the hole may be arranged at a middle position or two ends of the edge; and when being arranged in the screen center, the bump, the nick and/or the hole may be arranged in one or more regions of an upper region, left upper region, left-side region, left lower region, lower region, right lower region, right-side region and right upper region of the screen. When being arranged in multiple regions, the bump, the nick and the hole may be distributed in a centralized manner and may also be distributed in a decentralized manner; and they may be symmetrically distributed and may also be asymmetrically distributed. In an alternative embodiment, the number of the bump, the nick and/or the hole is not limited.

Since the irregularly-shaped screen covers an upper frontal region and/or lower frontal region of the touch display screen to form the display region and/or the operating region, the touch display screen occupies a larger space on the front panel of the terminal, and the irregularly-shaped screen also has a higher screen-to-body ratio. In some embodiments, at least one front panel component is accommodated in the nick and/or the hole, and the front panel component includes at least one of a camera, a fingerprint sensor, a proximity light sensor, a distance sensor, a receiver, an environmental luminance sensor and a physical button.

Exemplarily, the nick may be formed in one or more edges, and the nick may be a semicircular nick, an orthogonal rectangular nick, a rounded rectangular nick or an irregularly-shaped nick. In a schematic example shown in FIG. 3C, the irregularly-shaped screen may be such a screen with a design that a semicircular nick 43 is formed in a central position of an upper edge of the touch display screen 130, and a recessed position formed by the semicircular nick 43 is used for accommodating at least one front panel component of the camera, the distance sensor (also called a proximity sensor), the receiver and the environmental luminance sensor. Schematically, as shown in FIG. 3D, the irregularly-shaped screen may be such a screen with a design that a semicircular nick 44 is formed in a central position of a lower edge of the touch display screen 130, and a recessed position formed by the semicircular nick 44 is used for accommodating at least one component of the physical button, the fingerprint sensor and a microphone. In a schematic example shown in FIG. 3E, the irregularly-shaped screen may be such a screen with a design that a semielliptical nick 45 is formed in the central position of the lower edge of the touch display screen 130, meanwhile, a semielliptical nick is also formed in the front panel of the terminal 100, the two semielliptical nicks enclose an elliptical region, and the elliptical region is used for accommodating the physical button or a fingerprint recognition module. In a schematic example shown in FIG. 3F, the irregularly-shaped screen may be such a screen with a design that at least one small hole 45 is formed in an upper half part of the touch display screen 130, and a recessed position formed by the small hole 45 is used for accommodating at least one front panel component of the camera, the distance sensor, the receiver and the environmental luminance sensor.

In addition, those skilled in the art can understand that the structure of the terminal 100 shown in the above drawings does not form any limit to the terminal 100, and the terminal may include more or fewer components than those shown in the figures, or some components may be combined or different component arrangements are adopted. For example, the terminal 100 further includes components such as a radio frequency circuit, an input unit, a sensor, an audio circuit, a Wi-Fi component, a power supply and a Bluetooth module, which will not be elaborated herein.

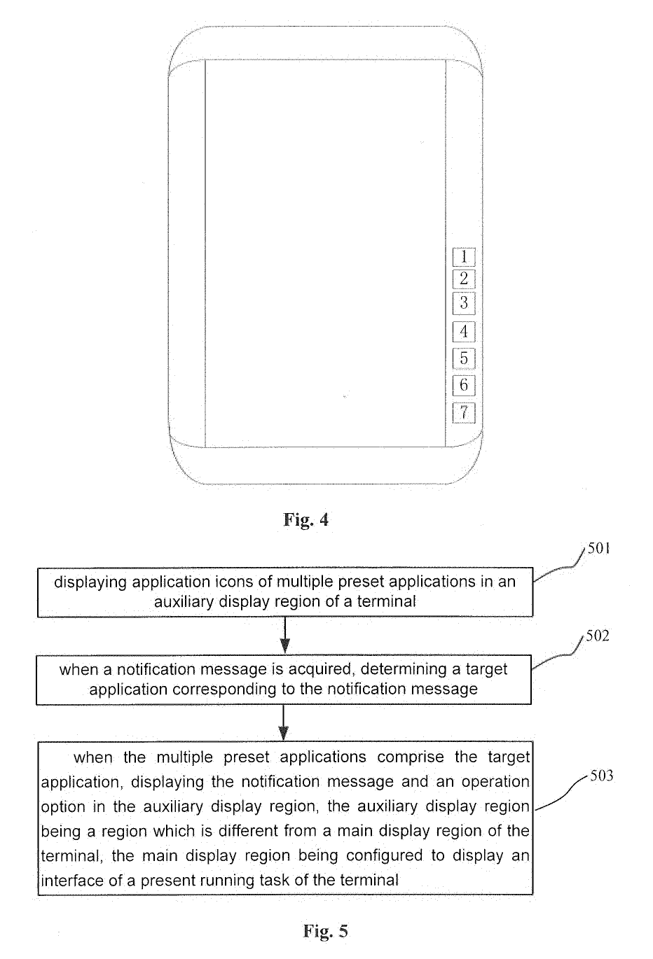

In at least one alternative embodiment, a terminal may be provided with a main display region and an auxiliary display region. The main display region is positioned in middle of a screen of the terminal and may be configured to display an interface (i.e., task interface) of a present running task of the terminal. The auxiliary display region is positioned on two sides of the screen of the terminal and is configured to display application icons of multiple preset applications. The two sides of the screen of the terminal may be the left side and the right side of the terminal, may also be the top side and the bottom side of the terminal. The application icons of the multiple preset applications may be vertically arranged in the auxiliary display region, in the case that the auxiliary display region is positioned on the left side and/or the right side of the terminal. The application icons of the multiple preset applications may be horizontally arranged in the auxiliary display region, in the case that the auxiliary display region is positioned on the top side and/or the bottom side of the terminal. In a possible implementation mode, the terminal is provided with a curved screen, the main display region includes a flat display region of the curved screen, and the auxiliary display region includes a curved display region of the curved screen. Referring to FIG. 4, a schematic diagram of the display regions of the terminal is provided. A middle display region of the screen of the terminal is the main display region, a side-edge display region is the auxiliary display region, and the application icons of the multiple preset applications such as an icon 1, an icon 2, . . . and an icon 7 may be displayed in the auxiliary display region.

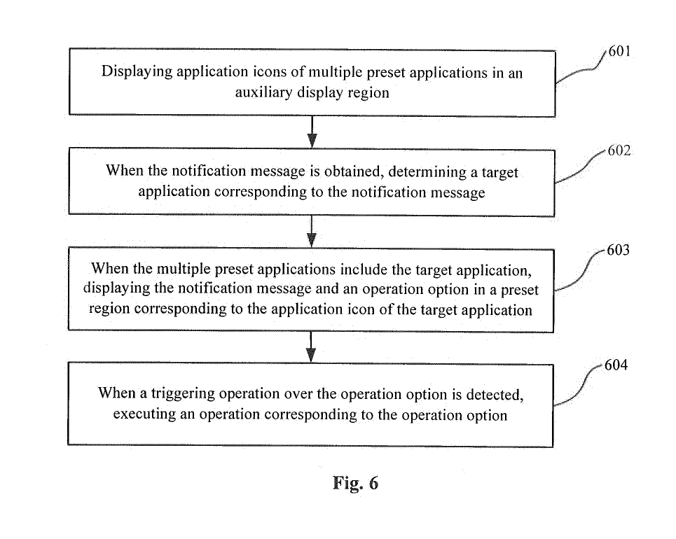

In at least one alternative embodiment, a technical solution is provided, and an alternative process refers to the embodiment shown in FIG. 5 or 6. In the technical solution, application icons of multiple preset applications are displayed in an auxiliary display region, and when a notification message of any one preset application is obtained, the terminal displays the notification message and an operation option nearby the application icon of the preset application in the auxiliary display region.

FIG. 5 is a flowchart of a method for displaying a notification message according to an embodiment of the disclosure. The method is applied to a terminal with a main display region and an auxiliary display region. Referring to FIG. 5, the method includes the following blocks.

In 501, application icons of multiple preset applications are displayed in the auxiliary display region of a terminal.

In 502, when a notification message is acquired, a target application corresponding to the notification message is determined.

In 503, when the multiple preset applications comprise the target application, the notification message and an operation option are displayed in auxiliary display region, the auxiliary display region being a region which is different from a main display region of the terminal, the main display region being configured to display an interface of a present running task of the terminal.

According to the method provided by the embodiment of the disclosure, when the notification message of the preset application is obtained, the terminal can display the notification message and the operation option nearby the preset application in the auxiliary display region. Since the auxiliary display region is different from the main display region configured to display a task interface in the terminal, when a manner of displaying the notification message in the auxiliary display region is adopted, the task interface can be prevented from being covered, and a running task of the terminal in the main display region also can be prevented from being disturbed.

There may be manners for displaying the notification message and an operation option in auxiliary display region. In an alternative embodiment, the notification message and an operation option may be displayed in a preset region in the auxiliary display region. In another alternative embodiment, the notification message and an operation option may be displayed at an upper layer of an interface of a preset region of the auxiliary display region. In an example embodiment, a preset region corresponding to the application icon of the target application is determined, and then the notification message and an operation option may be displayed at an upper layer of an interface of a preset region.

The above method for displaying the notification message may be applied in many application scenarios. In an alternative embodiment, in the above scenario of displaying an application icon in the auxiliary display region, a possible implementation mode is provided. In the possible implementation mode, application icons of multiple preset applications are displayed in the auxiliary display region, and the application icons of the multiple preset applications comprise the application icon of the target application corresponding to the notification message. In the possible implementation mode, displaying the notification message and the operation option in the preset region of the auxiliary display region may comprise: a target application corresponding to the notification message is determined; since the application icon of the target application is displayed in the auxiliary display region, the notification message and the operation option are displayed in the preset region, corresponding to an application icon of the target application, of the auxiliary display region.

In the possible implementation mode, the application icons of multiple preset applications are displayed in the auxiliary display region; when the notification message is obtained, a target application corresponding to the notification message is determined; when the multiple preset applications include the target application, the notification message and an operation option are displayed in a preset region corresponding to the application icon of the target application.

In at least one alternative embodiment, many arrangement manners for arranging the application icons of multiple preset applications are displayed in the auxiliary display region. In an alternative embodiment, the application icons of multiple preset applications displayed in the auxiliary display region may be arranged vertically, in the case that the auxiliary display region is positioned on the left side and/or the right side of the terminal. In another alternative embodiment, the application icons of multiple preset applications displayed in the auxiliary display region may be arranged horizontally, in the case that the auxiliary display region is positioned on the top side and/or the bottom side of the terminal.

In a possible implementation mode, the application icons of the multiple preset applications are vertically arranged in the auxiliary display region, and displaying the notification message and the operation option in the preset region, corresponding to the application icon of the target application, of the auxiliary display region may include at least one of the followings:

the application icon of the target application is moved to a first position in the application icons of the multiple preset applications, and the notification message and the operation option are displayed in a region above the application icon of the target application;

the application icon of the target application is moved to a first position in the application icons of the multiple preset applications, and the notification message and the operation option are displayed in a region below the application icon of the target application;

the application icon above the application icon of the target application is moved upwards, and the notification message and the operation option are displayed in a region between the application icon of the target application and the other application icons; in an example embodiment, the notification message and the operation option are displayed in a region between the application icon of the target application and the application icon above the application icon of the target application;

the application icon below the application icon of the target application is moved downwards, and the notification message and the operation option are displayed in a region between the application icon of the target application and the other application icons; in an example embodiment, the notification message and the operation option are displayed in a region between the application icon of the target application and the application icon below the application icon of the target application;

the notification message and the operation option are displayed in a left-side region of the application icon of the target application;

the notification message and the operation option are displayed in a right-side region of the application icon of the target application.

In a possible implementation mode, the application icons of the multiple preset applications are horizontally arranged in the auxiliary display region, and displaying the notification message and the operation option in the preset region, corresponding to the application icon of the target application, of the auxiliary display region may include at least one of the followings:

the application icon of the target application is moved to a first position in the application icons of the multiple preset applications, and the notification message and the operation option are displayed in a region on the left side of the application icon of the target application;

the application icon of the target application is moved to a first position in the application icons of the multiple preset applications, and the notification message and the operation option are displayed in a region between the application icon of the target application and an application icon on the right side of the application icon of the target application;

an application icon on the left side of the application icon of the target application is moved left, and the notification message and the operation option are displayed in a region between the application icon of the target application and the application icon on the left side of the application icon of the target application;

an application icon right of the application icon of the target application is moved right, and the notification message and the operation option are displayed in a region between the application icon of the target application and the application icon right of the application icon of the target application;

the notification message and the operation option are displayed in a region above the application icon of the target application;

the notification message and the operation option are displayed in a region below the application icon of the target application.

In a possible implementation mode, moving the application icon of the target application to the first position in the application icons of the multiple preset applications may include that:

a display position of the application icon of the target application is modified into the first position in the application icons of the multiple preset applications, and display positions of other application icons in the application icons of the multiple preset applications are correspondingly modified.

In a possible implementation mode, when the display positions of the other application icons in the application icons of the multiple preset applications are correspondingly modified, the modifying manner may be different according to the region where the notification message and the operation option need to be displayed.

When the notification message and the operation option need to be displayed in the region above the application icon of the target application, or in the region on the left side of the application icon of the target application, modifying the display positions of the other application icons in the application icons of the multiple preset applications are correspondingly may include at least one of the followings:

a display position of a first icon is modified into an original display position of a icon which is the next icon of the first icon, the first icon being an application icon, which is displayed according to a display sequence before the application icon of the target application in the application icons of the multiple preset applications;

a display position of a second icon is modified into an original display position of the application icon of the target application, the second icon being an application icon, which is displayed in a first position according to a display sequence, in the application icons of the multiple preset applications.

When the notification message and the operation option need to be displayed in the region below the above the application icon of the target application, or in the region right of the application icon of the target application, modifying the display positions of the other application icons in the application icons of the multiple preset applications are correspondingly may include: a display position of a third icon is modified into an original display position of a icon which is the next icon of the third icon, the third icon being an application icon, which is displayed according to a display sequence after the application icon of the target application, in the application icons of the multiple preset applications, and a display position of a fourth icon is modified into an original display position of a icon which is the next second icon of the fourth icon, the fourth icon being an application icon, which is displayed according to a display sequence before the application icon of the target application, in the application icons of the multiple preset applications.

In a possible implementation mode, moving upwards the application icon above the application icon of the target application may include that at least one of following:

the application icon above the application icon of the target application is moved upwards according to a display position of the application icon above the application icon of the target application and a preset movement distance;

the application icon above the application icon of the target application is moved upwards to a top of the auxiliary display region.

In a possible implementation mode, moving downwards the application icon below the application icon of the target application may include that at least one of following:

the application icon below the application icon of the target application is moved downwards according to a display position of the application icon below the application icon of the target application and a preset movement distance;

the application icon below the application icon of the target application is moved downwards to a bottom of the auxiliary display region.

In a possible implementation mode, moving left the application icon on the left side of the application icon of the target application comprises at least one of following:

the application icon on the left side of the application icon of the target application is moved left according to a display position of the application icon on the left side of the application icon of the target application and a preset movement distance;

the application icon on the left side of the application icon of the target application is moved left to a left-most side of the auxiliary display region.

In a possible implementation mode, moving right the application icon right of the application icon of the target application comprises at least one of following: the application icon right of the application icon of the target application is moved right according to a display position of the application icon right of the application icon of the target application and a preset movement distance;

the application icon right of the application icon of the target application is moved right to a right-most side of the auxiliary display region.

In a possible implementation mode, the terminal is provided with one of following screens:

a curved screen, the main display region including a flat display region of the curved screen, and the auxiliary display region including a curved display region of the curved screen;

a full screen, the main display region including a middle display region of the full screen, and the auxiliary display region including a display region on at least one side of the full screen, such as a display region on the left side of the full screen, or a display region on the bottom side of the full screen;

an irregularly-shaped screen, the main display region including a middle display region of the irregularly-shaped screen, and the auxiliary display region including a display region on at least one side of the irregularly-shaped screen, such as a display region on the left side of the irregularly-shaped screen, or a display region on the bottom side of the irregularly-shaped screen.

In a possible implementation mode, the auxiliary display region is positioned on two sides of the screen of the terminal.

All of the alternative technical solutions may be freely combined into optional embodiments of the disclosure, which will not be elaborated one by one herein.

FIG. 6 is a flowchart of a method for displaying a notification message according to another embodiment of the disclosure. The method is executed by a terminal, and referring to FIG. 6, the method includes:

At 601, application icons of multiple preset applications are displayed in an auxiliary display region.

In at least one alternative embodiment, the multiple preset applications may be preset system default applications of the terminal and may also be autonomously set by a user. Under the condition of autonomously setting by the user, the terminal may provide a function of setting a preset application. The terminal may display a setting interface when receiving a setting request for requesting to set a preset application. Application identifiers of all applications installed on the terminal may be provided in the setting interface, the user may select some application identifiers from the displayed application identifiers, and the terminal determines the applications corresponding to the application identifiers selected by the user as the preset applications.

The preset applications are displayed in the auxiliary display region of the terminal, and when the terminal executes a task in a main display region, the user may operate the application icon of any one preset application in the auxiliary display region, as to realize a function of the preset application of which the application icon is operated. It is not required to quit the present running task in the main display region to return to a desktop of the terminal and then operate the application icon on the desktop, so that convenience for use of the preset application is greatly enhanced.

At 602, when a notification message is obtained, a target application corresponding to the notification message is determined.

In at least one alternative embodiment, the operation that the terminal obtains the notification message may include that: the terminal receives the notification message, for example, the terminal receives a chat message from a friend of a social application, or, the terminal generates the notification message, for example, when an incoming call event occurs, the terminal may locally generate an incoming call notification message.

In at least one alternative embodiment, when a notification message of any one application is obtained, the terminal may determine the target application corresponding to the notification message and execute different blocks according to different applications, namely displaying the notification message in different display manners. When the target application corresponding to the notification message is not a preset application, the terminal may display the notification message in any display manner, for example, except for the display manner described by the subsequent Block 603 to Block 604); and when the target application corresponding to the notification message is a preset application, the terminal may execute subsequent Block 603 to Block 604.

In a possible implementation mode, the operation that the terminal determines the target application corresponding to the notification message may include that: the terminal determines an application identifier corresponding to the notification message according to a message packet name of the notification message, namely determining the target application corresponding to the notification message, the message packet name carrying an application identifier of an application on the terminal. In an alternative embodiment, the terminal may determine the application corresponding to the application identifier carried in the message packet name of the notification message as the target application corresponding to the notification message. A manner for rapidly and accurately determining the target application corresponding to the notification message is provided.

At 603, when the multiple preset applications include the target application, the notification message and an operation option are displayed in a preset region corresponding to the application icon of the target application.

In at least one alternative embodiment, the preset region corresponding to the application icon of the target application may refer to a region nearby the application icon of the preset application, for example, a region above or region below the application icon of the target application. A lower edge of the region above the application icon of the target application may be overlapped with or spaced by a certain distance from an upper edge of the application icon of the target application, and an upper edge of the region below the application icon of the target application may be overlapped with or spaced by a certain distance from a lower edge of the application icon of the target application. The preset region may also be a left-side region or right-side region of the application icon of the target application, a right edge of the left-side region is overlapped with or spaced by a certain distance from a left edge of the application icon of the target application, and a left edge of the right-side region is overlapped with or spaced by a certain distance from a right edge of the application icon of the target application. The operation option may include a first operation option and a second operation option, the first operation option is configured to read the notification message or accept the notification message, and the second operation option is configured to ignore the notification message or reject the notification message. The notification message displayed by the terminal may be a prompting message, and the user may view a specific content of the notification message through the first operation option.

In at least one alternative embodiment, the application icons of the multiple preset applications are displayed in the auxiliary display region of the terminal, so that the terminal, when obtaining a notification message of any one preset application, may display the notification message and the operation option in the auxiliary display region to avoid disturbing the running present task of the terminal in the main display region. Therefore, after determining the target application corresponding to the notification message at Block 602, the terminal may further determine whether the target application is included in the multiple preset applications or not, namely whether the target application is a preset application or not.

At Block 602, when the multiple preset applications include the target application, it is indicated that the target application is a preset application and the application icon of the target application is displayed in the auxiliary display region of the terminal, so that the terminal can display the notification message and the operation option in the auxiliary display region. Considering that the application icons of the multiple preset applications are displayed in the auxiliary display region, for preventing any one application icon from being covered, the terminal may display the notification message and the operation option in a blank region of the auxiliary display region. For making it convenient for the user to directly learn about the specific application corresponding to the notification message, the terminal may display the notification message and the operation option in the preset region corresponding to the application icon of the target application.

In at least one alternative embodiment, the operation that the terminal displays the notification message and the operation option in the preset region corresponding to the application icon of the target application may include the following possible implementation modes.

In the first possible implementation mode, the application icon of the target application is moved to a first position in the application icons of the multiple preset applications, and the notification message and the operation option are displayed in a region above and/or below the application icon of the target application. The following alternative embodiment is described by taking an example of that the application icon of the target application is moved to a first position in the application icons of the multiple preset applications, and the notification message and the operation option are displayed in a region above the application icon of the target application.

For the condition shown in FIG. 4 that the blank region in the auxiliary display region is positioned above the first position in the application icons of the multiple preset applications, wherein the first position is obtained by sequencing according to a sequence from top to bottom. The terminal may move the application icon of the target application to the first position in the application icons of the multiple preset applications, thereby displaying the notification message of the target application in the blank region above the application icon of the target application.

In at least one alternative embodiment, the operation that the terminal moves the application icon of the target application to the first position in the application icons of the multiple preset applications may include that: the terminal modifies a display position of the application icon of the target application into the first position in the application icons of the multiple preset applications, and correspondingly modifies the display positions of the other application icons in the application icons of the multiple preset applications. Displaying of the application icon at the first position is implemented in a manner of modifying the display position. Since the blank region exists nearby the first position, the terminal can display the notification message in the blank region nearby the application icon of the target application, and in such a manner, displaying of the notification message may not cover a task interface of the main display region and may also not cover the other application icons in the auxiliary display region.

In at least one alternative embodiment, the operation that the terminal correspondingly modifies the display positions of the other application icons may be performed in the following two manners.

The first manner: the display position of a first icon is modified into the original display position of the icon which is the next icon of the first icon, the first icon being an application icon, which is displayed according to a display sequence before the application icon of the target application in the application icons of the multiple preset applications.

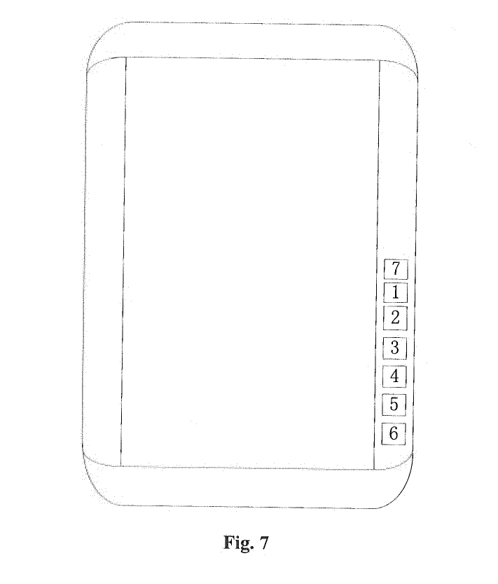

In this manner, the application icon corresponding to the notification message is moved to the first position and all of the application icons of which display sequences are before the application icon of the target application before movement are moved backwards by one icon. As shown in FIG. 4, display sequences of the application icons of the multiple preset application before movement are: an icon 1 (the first position), an icon 2, . . . and an icon 7. Referring to FIG. 7, a schematic diagram of the application icons of the multiple preset applications in the auxiliary display region is provided. For example, the icon 7 in FIG. 4 is the application icon corresponding to the notification message. After movement in the above manner, the display sequences shown in FIG. 4 are changed into display sequences shown in FIG. 7: the icon 7 (the first position), the icon 1, the icon 2, . . . and the icon 6. It can be seen that display positions of the icons 1 to 6 (i.e., the first icon) before the icon 7 after movement are respectively the original display positions of the icon which is the next icon of the corresponding icons before movement. For example, the display position of the icon 1 is the original display position of the icon 2, the display position of the icon 2 is the original display position of the icon 3, . . . , and the display position of the icon 6 is the original display position of the icon 7.

By modifying the display positions of the application icon corresponding to the notification message and modifying the display positions of the other application icons influenced by the movement of the application icon corresponding to the notification message, the application icon of the target application may be moved to the first position for displaying. An effective manner of moving the application icon is provided.

The second manner: the display position of a second icon is modified into the original display position of the application icon of the target application, the second icon being an application icon, which is displayed in a first position according to a display sequence, in the application icons of the multiple preset applications.

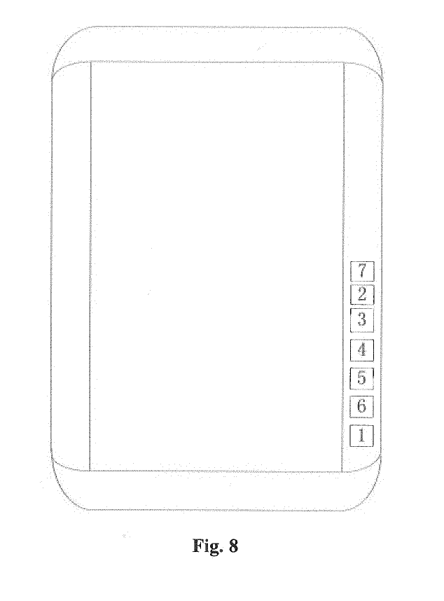

In this manner, the display positions of the application icon corresponding to the notification message and the application icon originally at the first position are exchanged, and the display positions of the other application icons are kept unchanged. Referring to FIG. 8, a schematic diagram of the application icons of the multiple preset applications in the auxiliary display region is provided. After movement in this manner, the display sequences shown in FIG. 4 are changed into: the icon 7 (the first position), the icon 2, . . . and the icon 1. It can be seen that the display position of the icon 1 (i.e., the second icon) originally at the first position after movement is the original display position of the icon 7 (the application icon corresponding to the notification message) before movement.

By exchanging the display position of the application icon corresponding to the notification message and the display position of the application icon originally at the first position, the application icon of the target application can be moved to the first position for displaying. Since the display positions of the two icons are required to be modified, movement efficiency is improved.

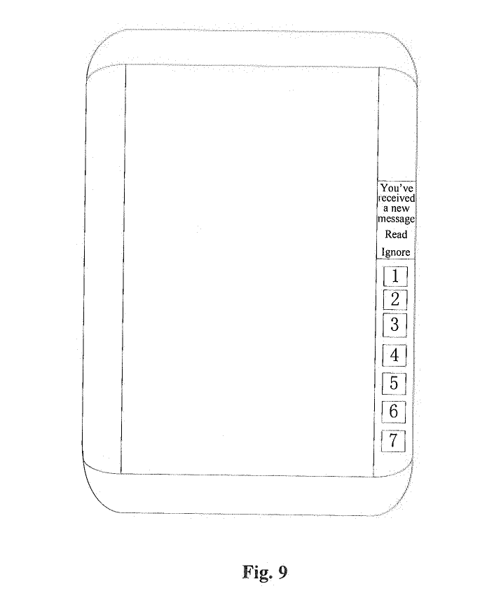

After moving the application icon corresponding to the notification message to the first position, the terminal may display the notification message and the operation option in the region above the application icon of the target application (i.e., the blank region above the first position). For example, the terminal may display the notification message and the operation option in a form of a message prompting box. The terminal may adaptively display the message prompting box according to a display size of the auxiliary display region to ensure that the notification message in the message prompting box can be completely displayed. Referring to FIG. 9, a schematic diagram of displaying the notification message and the operation option is provided. The terminal may display one message prompting box in the region above the application icon of the target application in the auxiliary display region and display the notification message “You've received a new message” and two operation options “Read” and “Ignore” in the message prompting box. A width of the message prompting box shown in FIG. 9 is the same as a width of the auxiliary display region, and of course, the width of the message prompting box may also be smaller than the width of the auxiliary display region. There are no limits made in the embodiment of the disclosure. In addition, the two operation options shown in FIG. 9 are displayed up and down. Of course, when the width of the auxiliary display region is relatively large and the two operation options may be accommodated, the two operation options may be displayed side by side. There are no limits made in the embodiment of the disclosure.

In addition, in order to enable the user to more directly learn about the specific application icon corresponding to the notification message in the auxiliary display region, the terminal may display the application icon, the notification message and the operation option of the target application according to a preset display effect. The preset display effect is configured to distinguish the application icon of the target application corresponding to the notification message from the other application icons in the auxiliary display region. For example, the preset display effect may be a display effect of adding a background color to make the background color of the application icon of the target application different from background colors of the other application icons, so that the user may rapidly distinguish the specific icon corresponding to the notification message in the auxiliary display region through the background colors. Of course, the preset display effect may further be any other display effect capable of realizing a distinguishing function, for example, a display effect of enlarging the icon. There are no limits made in the embodiment of the disclosure.

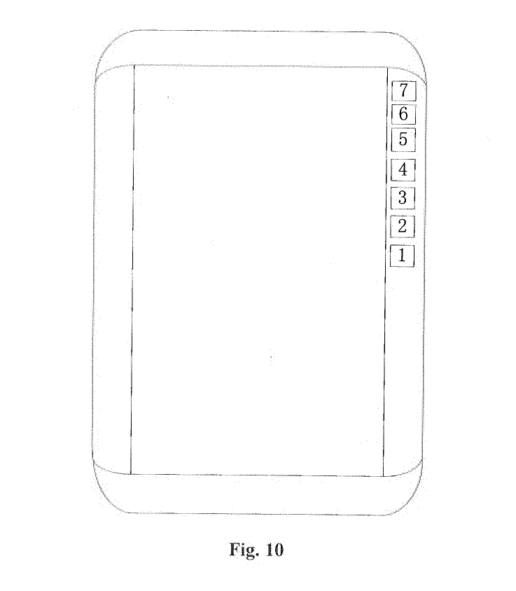

It is important to note that the possible implementation mode is described with the condition shown in FIG. 4 that the blank region in the auxiliary display region is positioned above the first position in the application icons of the multiple preset applications, wherein the first position is sequenced according to the sequence from top to bottom as an example. In another embodiment of the disclosure, the blank region in the auxiliary display region may also be positioned below the first position in the application icons of the multiple preset applications, wherein the first position is sequenced according to a sequence from bottom to top. Referring to FIG. 10, a schematic diagram of the application icons of the multiple preset applications in the auxiliary display region is provided. The display sequences of the application icons of the multiple preset applications are: the icon 1 (the first position), the icon 2, . . . and the icon 7.

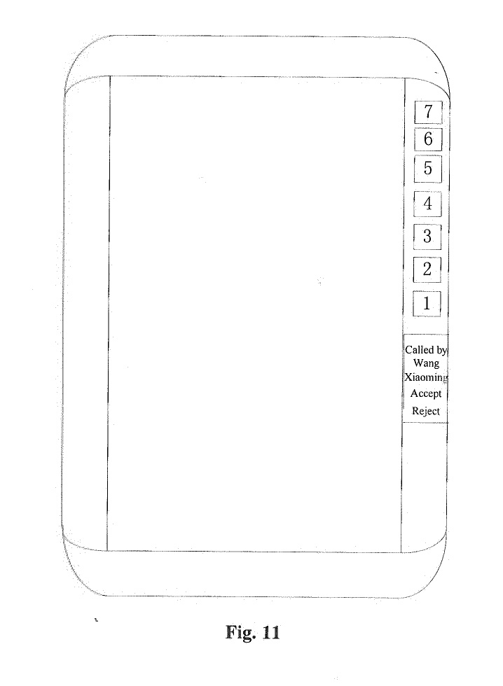

For the condition shown in FIG. 10 that the blank region in the auxiliary display region is positioned below the first position, wherein the first position is sequenced according to the sequence from bottom to top, the terminal, after moving the application icon corresponding to the notification message to the first position, may display the notification message and the operation option in the region below the application icon of the target application (i.e., the blank region below the first position). In an alternative embodiment, a process that the terminal moves the application icon of the target application to the first position for displaying is similar to the abovementioned possible implementation mode and will not be elaborated herein. Referring to FIG. 11, a schematic diagram of displaying the notification message and the operation option is provided. The terminal may display the notification message and the operation option in the region below the application icon of the target application. As shown in FIG. 11, a notification message “Called by Wang Xiaoming” and two operation options “Accept” and “Reject” are displayed.

It is to be noted that the abovementioned possible implementation mode is described by taking an example that the notification message and the operation option are displayed in the region above the application icon of the target application. The abovementioned possible implementation mode may be implemented by the following operation that the notification message and the operation option are displayed in the region between the application icon of the target application and an application icon below the application icon of the target application. The process different from the operation that the notification message and the operation option are displayed in the region above the application icon of the target application is that: since there is no blank region below the application icon of the target application, in order to display the notification message and the operation option in the region below the application icon of the target application, the application icons below the application icon of the target application are moved downwards to reserve a blank region below the application icon of the target application. The notification message and the operation option are displayed in the left blank region below the application icon of the target application.

In at least one alternative embodiment, when moving the application icon of the target application to the first position in the application icons of the multiple preset applications, the same process with the operation that the notification message and the operation option are displayed in the region above the application icon of the target application is that: a display position of the application icon of the target application is modified into the first position in the application icons of the multiple preset applications.

The different process with the operation that the notification message and the operation option are displayed in the region above the application icon of the target application is that: when the notification message and the operation option need to be displayed in the region below the application icon of the target application, correspondingly modifying the display positions of the other application icons in the application icons of the multiple preset applications may comprises: a display position of a third icon is modified into an original display position of a icon which is the next icon of the third icon, the third icon being an application icon, which is displayed according to a display sequence after the application icon of the target application, in the application icons of the multiple preset applications, and a display position of a fourth icon is modified into an original display position of a icon which is the next second icon of the fourth icon, the fourth icon being an application icon, which is displayed according to a display sequence before the application icon of the target application, in the application icons of the multiple preset application.

Similarly, the first position in the above described embodiment is sequenced according to the sequence from top to bottom, and the notification message and the operation option are displayed in the region between the application icon of the target application and an application icon below the application icon of the target application. In another alternative embodiment, the first position may be sequenced according to the sequence from bottom to top, and the notification message and the operation option are displayed in the region above the application icon of the target application.

In addition, the above first possible implementation mode is described by taking an example that the application icons of the multiple preset applications are vertically arranged in the auxiliary display region. The above first possible implementation mode may be applied in the condition that the application icons of the multiple preset applications are horizontally arranged in the auxiliary display region.

In at least one alternative embodiment, when the application icons of the multiple preset applications are horizontally arranged in the auxiliary display region, displaying the notification message and the operation option in the preset region, corresponding to the application icon of the target application, of the auxiliary display region may comprise at least one of following:

the application icon of the target application is moved to a first position in the application icons of the multiple preset applications, and the notification message and the operation option are displayed in a region on the left side of the application icon of the target application;

the application icon of the target application is moved to a first position in the application icons of the multiple preset applications, and the notification message and the operation option are displayed in a region between the application icon of the target application and an application icon on the right side of the application icon of the target application.

The specific process of the condition of arranging horizontally is similar to the specific process of the condition of arranging vertically, the same or similar description is not repeated herein.

In the second possible implementation mode, the application icon above the application icon of the target application is moved upwards, and/or, the application icon below the application icon of the target application is moved downwards, and the notification message and the operation option are displayed in a region between the application icon of the target application and the other application icons. In an alternative embodiment, an application icon above the application icon of the target application is moved upwards, and the notification message and the operation option are displayed in a region between the application icon of the target application and the application icon above the application icon of the target application; In an alternative embodiment, an application icon below the application icon of the target application is moved downwards, and the notification message and the operation option are displayed in a region between the application icon of the target application and the application icon below the application icon of the target application.

For the condition shown in FIG. 4 that the blank region in the auxiliary display region is positioned above the first position in the application icons of the multiple preset applications, wherein the first position is sequenced according to the sequence from top to bottom, when the display position of the application icon of the target application is not the first position, it is indicated that there is not a blank region but another icon displayed above the application icon of the target application, the terminal may move upwards the application icon above the application icon of the target application to reserve a blank region between the application icon of the target application and the application icon above the application icon of the target application, as to display the notification message. In at least one alternative embodiment, the terminal may move upwards the application icon above the application icon of the target application in the following two manners.

The first manner: the application icon above the application icon of the target application is moved upwards according to the display position of the application icon above the application icon of the target application and a preset movement distance.

In this manner, the terminal may determine a target display position after the movement of the application icon above the application icon of the target application according to the present display position of the application icon above the application icon of the target application and the preset movement distance, a distance between the target display position and the present display position being the preset movement distance, and then the terminal modifies the display position of the application icon above the application icon of the target application into the target display position, thus moving the application icon above the application icon of the target application to the target display position for displaying.

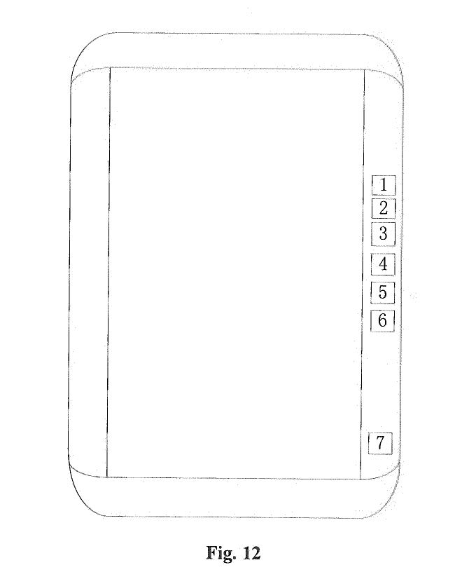

In this manner, an application icon before the application icon corresponding to the notification message (i.e., the application icon above the application icon of the target application) is moved upwards by the preset movement distance. As shown in FIG. 4, the display sequences of the application icons of the multiple preset applications before movement are: the icon 1 (the first position), the icon 2, . . . and the icon 7. For example, the icon 7 is the application icon corresponding to the notification message, the application icons above the application icon of the target application are the icon 1 (the first position), the icon 2, . . . , and the icon 6, and in the movement according to the above manner, all of the icons 1 to 6 are required to be moved upwards by the preset movement distance. Referring to FIG. 12, a schematic diagram of the application icons of the multiple preset applications in the auxiliary display region is provided. After movement in this manner, a region is reserved between the icon 7 and the icons 1 to 6 (i.e., the application icons above the application icon of the target application).

It is important to note that, for ensuring that the notification message may be completely displayed in the region reserved after movement of the application icons, the preset movement distance cannot be too short. Therefore, the terminal may set the preset movement distance according to a fixed size, wherein the fixed size refers to a display size of the notification message. For example, when the terminal adopts the message prompting box to display the notification message, the fixed size is a size of the message prompting box. In at least one alternative embodiment, the terminal may set the preset movement distance according to a height in the fixed size, for example, the preset movement distance is set to be more than or equal to the height in the fixed size.

The second manner: the application icon above the application icon of the target application is moved upwards to a top of the auxiliary display region.

In this manner, when there is one application icon above the application icon of the target application, that is, there is one application icon before the application icon corresponding to the notification message, the terminal may modify the display position of the application icon above the application icon of the target application into a top position of the auxiliary display region.

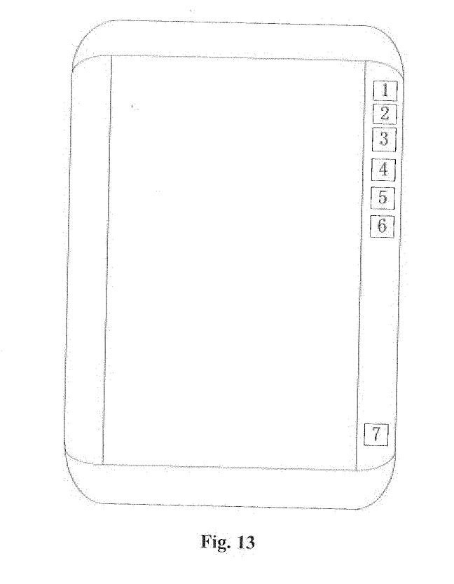

Of course, when there are multiple application icons above the application icon of the target application, that is, there are multiple application icons before the application icon corresponding to the notification message, the terminal may modify the display position of the application icon of which the display sequence is the first in the multiple application icons into the top position of the auxiliary display region and correspondingly modify the display positions of the other application icons to sequentially arrange downwards the multiple application icons from the top of the auxiliary display region. The multiple application icons are wholly displayed at the top of the auxiliary display region. Referring to FIG. 13, a schematic diagram of the application icons of the multiple preset applications in the auxiliary display region is provided. After movement in this manner, the icons 1 to 6 (i.e., the application icons above the application icon of the target application) before the icon 7 (i.e., the application icon corresponding to the notification message) are displayed at the top of the auxiliary display region.

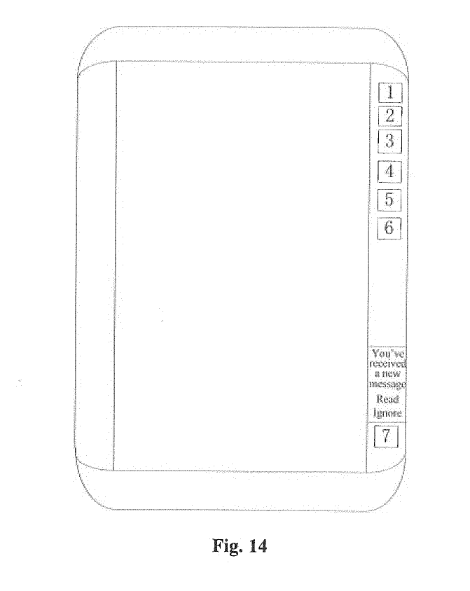

After moving the application icon before the application icon corresponding to the notification message, the terminal may display the notification message and the operation option in the blank region between the application icon of the target application and the application icon before the application icon of the target application. Referring to FIG. 14, a schematic diagram of displaying the notification message and the operation option is provided. The terminal may display a message prompting box in the blank region between the application icon of the target application and the application icon before the application icon of the target application in the auxiliary display region and display the notification message “You've received a new message” and two operation options “Read” and “Ignore” in the message prompting box.

The application icon nearby the application icon corresponding to the notification message is moved to reserve the region nearby the application icon of the target application as to display the notification message, so that displaying of the notification message may not cover the task interface of the main display region and may also not cover the other application icons in the auxiliary display region.

It is noted that the above alternative embodiment is described by taking an example that an application icon above the application icon of the target application is moved upwards, and the notification message and the operation option are displayed in a region between the application icon of the target application and the application icon above the application icon of the target application, the second possible implementation mode may be implemented by the following blocks: an application icon below the application icon of the target application is moved downwards, and the notification message and the operation option are displayed in a region between the application icon of the target application and the application icon below the application icon of the target application. For example, in the condition shown in FIG. 10 that the blank region in the auxiliary display region is positioned below the first position, wherein the first position is sequenced according to the sequence from bottom to top, the terminal may move downwards the application icon below the application icon of the target application to reserve a blank region configured to display the notification message between the application icon of the target application and the application icon below the application icon of the target application. In an alternative embodiment, the terminal may move downwards the application icon below the application icon of the target application according to the display position of the application icon below the application icon of the target application and the preset movement distance. Of course, the terminal may also directly move downwards the application icon below the application icon of the target application at the bottom of the auxiliary display region.

In addition, the above second possible implementation mode is described by in the condition that the application icons of the multiple preset applications are vertically arranged in the auxiliary display region. The above second possible implementation mode may be implemented in the condition that the application icons of the multiple preset applications are horizontally arranged in the auxiliary display region.

When the application icons of the multiple preset applications are horizontally arranged in the auxiliary display region, displaying the notification message and the operation option in the preset region, corresponding to the application icon of the target application, of the auxiliary display region comprises at least one of following:

an application icon on the left side of the application icon of the target application is moved left, and the notification message and the operation option are displayed in a region between the application icon of the target application and the application icon on the left side of the application icon of the target application;

an application icon right of the application icon of the target application is moved right, and the notification message and the operation option are displayed in a region between the application icon of the target application and the application icon right of the application icon of the target application.

In at least one alternative embodiment, moving left the application icon on the left side of the application icon of the target application comprises at least one of following:

the application icon on the left side of the application icon of the target application is moved left according to a display position of the application icon on the left side of the application icon of the target application and a preset movement distance;

the application icon on the left side of the application icon of the target application is moved left to a left-most side of the auxiliary display region.

In at least one alternative embodiment, moving right the application icon right of the application icon of the target application comprises at least one of following:

the application icon right of the application icon of the target application is moved right according to a display position of the application icon right of the application icon of the target application and a preset movement distance;

the application icon right of the application icon of the target application is moved right to a right-most side of the auxiliary display region.

The specific process of the alternative embodiment with the condition of arranging horizontally is similar to the process of the alternative embodiment with the condition of arranging vertical. The same or similar description is not repeated herein.

In addition, there are many manners of moving the application icons as a whole to reserve a blank region to display the notification message and the operation option, which are not described one by one.

In the first possible implementation mode and the second possible implementation mode, the display positions of the application icons in the auxiliary display region are modified to reserve the blank region nearby the application icon having the notification message, so that the notification message and the operation option can be displayed in the blank region in the auxiliary display region without covering the other application icons in the auxiliary display region.

In the third possible implementation mode, the preset region corresponding to the application icon of the target application is determined, and the notification message and the operation option are displayed at an upper layer of an interface of the preset region.

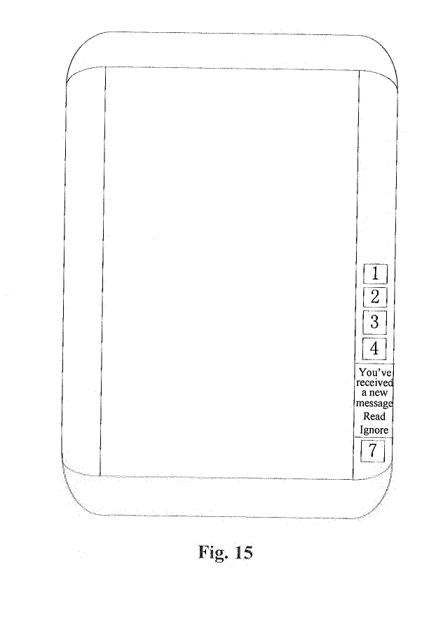

For the condition shown in FIG. 4 that the blank region in the auxiliary display region is positioned above the first position in the application icons of the multiple preset applications, wherein the first position is sequenced according to the sequence from top to bottom, when the present display position of the application icon of the target application is the first position, it is indicated that the region above the application icon of the target application is a blank region, so that the terminal can directly display the notification message and the operation option in the region above the application icon of the target application without moving the application icon of the target application. Of course, even if the present display position of the application icon of the target application is not the first position, the terminal may also determine the preset region corresponding to the application icon of the target application, for example, the region above the application icon of the target application, and display the notification message and the operation option at the upper layer of the interface of the preset region, but the other icons may be covered under this condition. Referring to FIG. 15, a schematic diagram of displaying the notification message and the operation option is provided. The terminal may display a message prompting box at the upper layer of the interface of the region above the application icon of the target application in the auxiliary display region and display the notification message “You've received a new message” and the two operation options “Read” and “Ignore” in the message prompting box, wherein the message prompting box covers the icon 5 and icon 6 above the icon 7.

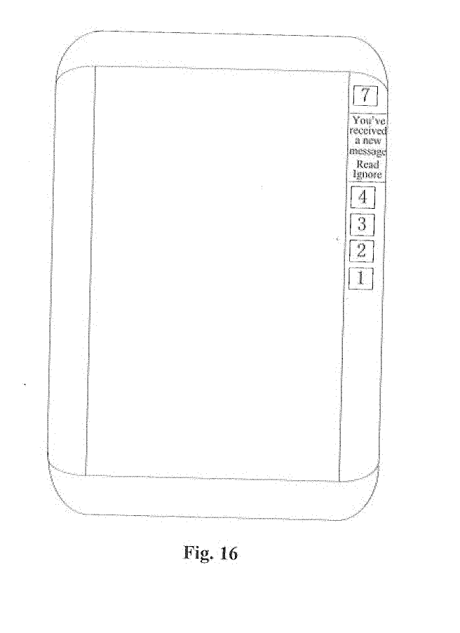

For the condition shown in FIG. 10 that the blank region in the auxiliary display region is positioned below the first position (i.e., the first position) in the application icons of the multiple preset applications, wherein the first position is sequenced according to the sequence from bottom to top, no matter whether the application icon of the target application is at the first position or not, the terminal may directly determine the preset region corresponding to the application icon of the target application without moving the application icon of the target application, for example, the region below the application icon of the target application, and display the notification message and the operation option at the upper layer of the interface of the preset region. Referring to FIG. 16, a schematic diagram of displaying the notification message and the operation option is provided. The terminal may display a message prompting box at the upper layer of the interface of the region below the application icon of the target application in the auxiliary display region and display the notification message “You've received a new message” and the two operation options “Read” and “Ignore” in the message prompting box, wherein the message prompting box covers the icon 5 and icon 6 below the icon 7.

The notification message is displayed nearby the application icon of the target application in the auxiliary display region, and since the auxiliary display region is different from the main display region configured to display the task interface, displaying of the notification message may not disturb the present running task of the terminal in the main display region.

In the first possible implementation mode, the second possible implementation mode and the third possible implementation mode, the specific implement is described by taking an example that the terminal displays the notification message and the operation option in the region above or region below the application icon of the target application in the auxiliary display region. Of course, the terminal may also display the notification message and the operation option in the left-side region of the application icon of the target application in the auxiliary display region, such as the following fourth possible implementation mode.

In the fourth possible implementation mode, the notification message and the operation option are displayed in the left-side and/or right-side region of the application icon of the target application. Of course, the fourth possible implementation mode may be implemented by the following blocks: the notification message and the operation option are displayed in the region above and/or below the application icon of the target application.

In at least one alternative embodiment, when the arrangement of the application icons of the preset application are different in the auxiliary display region, displaying the notification message and the operation option in the preset region, corresponding to the application icon of the target application, of the auxiliary display region may be different. In an alternative embodiment, displaying the notification message and the operation option in the preset region, corresponding to the application icon of the target application, of the auxiliary display region may comprise at least one of following:

when the application icons of the multiple preset applications are vertically arranged in the auxiliary display region, the notification message and the operation option are displayed in the left-side and/or right-side region of the application icon of the target application.

when the application icons of the multiple preset applications are horizontally arranged in the auxiliary display region, the notification message and the operation option are displayed in the region above and/or below the application icon of the target application.

Referring to FIG. 17, a schematic diagram of displaying the notification message and the operation option is provided. The terminal may display a message prompting box in the left-side region of the application icon of the target application in the auxiliary display region and display the notification message “You've received a new message” and the two operation options “Read” and “Ignore” in the message prompting box. A left edge of the message prompting box shown in FIG. 17 is in the auxiliary display region, and of course, when the width of the auxiliary display region is not large enough, the left edge of the message prompting box may also be overlapped with a left edge of the auxiliary display region. There are no limits made in the embodiment of the disclosure.

At 604, when a triggering operation over the operation option is detected, an operation corresponding to the operation option is executed.

In a possible implementation mode, when the terminal detects a triggering operation over the first operation option (for example, the “Read” option shown in FIG. 9 or the “Accept” option shown in FIG. 11), the terminal may display an interface of the application corresponding to the notification message. For example, the interface of the target application is displayed in the main display region, wherein the interface of the target application includes the specific content of the notification message. A rapid operation manner for entering the interface of the application on the basis of the operation option of the notification message is provided.

For example, when the notification message is a chat message from a friend of a social application, the interface of the target application may be a chat interface for the user and the friend; and when the notification message is an incoming call message, the interface of the target application may be an incoming call interface. The interface of the application is displayed, so that the user may conveniently read the specific content of the notification message and perform further processing on the notification message on the interface of the target application, for example, replying to, deleting or copying the notification message.

In another possible implementation mode, when the terminal detects a triggering operation over the second operation option (for example, the “Read” option shown in FIG. 9 or the “Reject” option shown in FIG. 11), the terminal may ignore the notification message or reject the notification message and keep the present interface unchanged. It is important to note that the embodiment of the disclosure is described with the condition that the terminal displays the notification message of the preset application in the auxiliary display region as an example, and actually, whether to display the notification message of the preset application in the auxiliary display region or not may be set by the user. For example, the terminal may provide a specified button, the specified button is configured for the user to set whether to display the notification message of the preset application in the auxiliary display region or not, and the specified button may have two states: on and off states. When the user sets the specified button into the on state, that is, the user sets the notification message to be displayed in the auxiliary display region, the terminal may display the notification message according to Block 601 to Block 604; when the user sets the specified button into the off state, that is, the user sets the notification message not to be displayed in the auxiliary display region, the terminal may display the notification message in any other display manner; and when the user does not execute any operation on the specified button, that is, the user does not perform setting, the terminal may display the notification message according to a system default setting, if the default setting is a setting that the specified button is on as a default, the terminal may adopt the display manner including Block 601 to Block 604, and if the default setting is a setting that the specified button is off as a default, the terminal may display the notification message in any other display manner.

According to the method provided by the embodiment of the disclosure, when a notification message of a preset application is obtained, the terminal may display the notification message and the operation option nearby the preset application in the auxiliary display region. Since the auxiliary display region is different from the main display region configured to display a task interface in the terminal, when a manner of displaying the notification message in the auxiliary display region is adopted, the task interface may be prevented from being covered, and a running task of the terminal in the main display region may also be prevented from being disturbed.

In at least one alternative embodiment, the terminal may move an application icon of the preset application to the first position nearby which there is a blank region in the auxiliary display region and display the notification message in the blank region nearby the application icon. The terminal may also move the application icon nearby the application icon of the preset application to reserve a blank region nearby the application icon in the auxiliary display region and display the notification message in the blank region. Therefore, not only a purpose of displaying the notification message nearby the preset application in the auxiliary display region is achieved, but also an effect of preventing the other application icons in the auxiliary display region from being covered is achieved.

In addition, the notification message and the operation option are displayed at the same time, and when reading the notification message, the user may execute the triggering operation on the operation option to rapidly implement the corresponding operation, so that a rapid operation manner of reading the specific content of the notification message is provided.

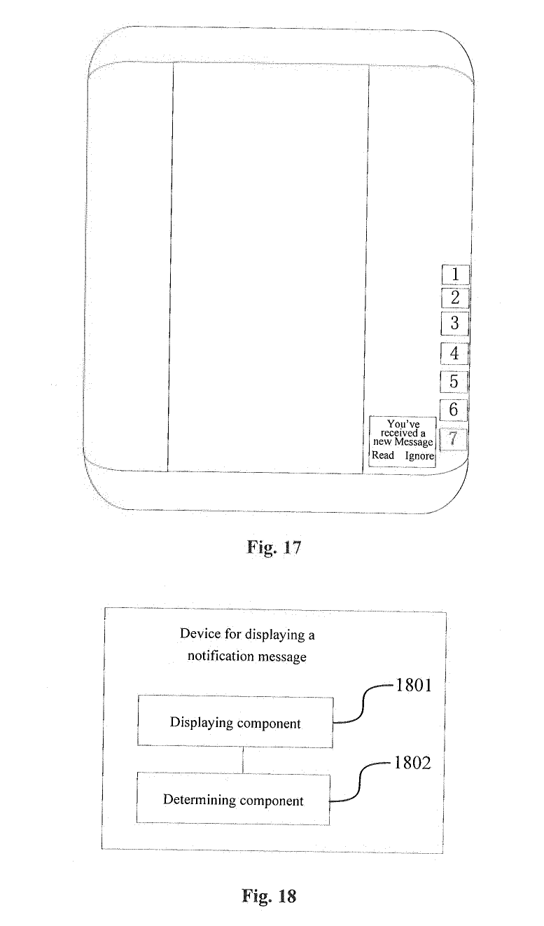

FIG. 18 is a structure diagram of a device for displaying a notification message according to an embodiment of the disclosure. The device is applied to a terminal with a main display region and an auxiliary display region. Referring to FIG. 18, the device includes:

a displaying component 1801, configured to display application icons of multiple preset applications in the auxiliary display region; and

a determining component 1802, configured to, when the notification message is obtained, determine a target application corresponding to the notification message, wherein

the displaying component 1801 is further configured to, when the multiple preset applications include the target application, display the notification message and an operation option in the auxiliary display region, the auxiliary display region being a region which is different from a main display region of the terminal, the main display region being configured to display an interface of a present running task of the terminal.

In a possible implementation mode, the displaying component 1801 is configured to implement at least one of following operations:

to move the application icon of the target application to a first position in the application icons of the multiple preset applications and display the notification message and the operation option in a region above the application icon of the target application;

to move the application icon of the target application to a first position in the application icons of the multiple preset applications and display the notification message and the operation option in a region below the application icon of the target application;

to move upwards the application icon above the application icon of the target application, and display the notification message and the operation option in a region between the application icon of the target application and the application icon above the application icon of the target application;

to move downwards the application icon below the application icon of the target application and display the notification message and the operation option in a region between the application icon of the target application and the application icon below the application icon of the target application:

to determine the preset region corresponding to the application icon of the target application and display the notification message and the operation option at an upper layer of an interface of the preset region;

to display the notification message and the operation option in a left-side region of the application icon of the target application;

to display the notification message and the operation option in a right-side region of the application icon of the target application;

to move the application icon of the target application to a first position in the application icons of the multiple preset applications, and display the notification message and the operation option in a region on the left side of the application icon of the target application;

to move the application icon of the target application to a first position in the application icons of the multiple preset applications, and display the notification message and the operation option in a region between the application icon of the target application and an application icon on the right side of the application icon of the target application;

to move left an application icon on the left side of the application icon of the target application, and display the notification message and the operation option in a region between the application icon of the target application and the application icon on the left side of the application icon of the target application;

to move right an application icon right of the application icon of the target application, and display the notification message and the operation option in a region between the application icon of the target application and the application icon right of the application icon of the target application;

to display the notification message and the operation option in a region above the application icon of the target application;

to display the notification message and the operation option in a region below the application icon of the target application.

In a possible implementation mode, the displaying component 1801 is configured to modify a display position of the application icon of the target application into the first position in the application icons of the multiple preset applications and correspondingly modify display positions of the other application icons in the application icons of the multiple preset applications.

In a possible implementation mode, the displaying component 1801 is configured to modify the display position of a first icon into the original display position of a icon which is the next icon of the first icon, the first icon being an application icon, which is displayed according to a display sequence before the application icon of the target application, in the application icons of the multiple preset applications; or,

the displaying component 1801 is configured to modify the display position of a second icon into the original display position of the application icon of the target application, the second icon being an application icon, which is displayed in a first position according to a display sequence, in the application icons of the multiple preset applications.

In a possible implementation mode, the displaying component 1801 is configured to implement at least one of following operations:

to move upwards the application icon above the application icon of the target application according to the display position of the application icon above the application icon of the target application and a preset movement distance;

to move upwards the application icon above the application icon of the target application to a top of the auxiliary display region.

In a possible implementation mode, the displaying component 1801 is configured to implement at least one of following operations:

to move downwards the application icon below the application icon of the target application according to the display position of the application icon below the application icon of the target application and a preset movement distance;

to move downwards the application icon below the application icon of the target application to a bottom of the auxiliary display region.

In a possible implementation mode, the displaying component 1801 is configured to implement at least one of following operations:

to move left the application icon on the left side of the application icon of the target application according to a display position of the application icon on the left side of the application icon of the target application and a preset movement distance;

to move left the application icon on the left side of the application icon of the target application to a left-most side of the auxiliary display region.

In a possible implementation mode, the displaying component 1801 is configured to implement at least one of following operations:

to move right the application icon right of the application icon of the target application according to a display position of the application icon right of the application icon of the target application and a preset movement distance;

to move right the application icon right of the application icon of the target application to a right-most side of the auxiliary display region.

In a possible implementation mode, the terminal is provided with one of following screens: a curved screen, the main display region includes a flat display region of the curved screen, and the auxiliary display region includes a curved display region of the curved screen; a full screen, the main display region including a middle display region of the full screen, and the auxiliary display region including a display region on at least one side of the full screen, such as a display region on the left side of the full screen, or a display region on the bottom side of the full screen; an irregularly-shaped screen, the main display region including a middle display region of the irregularly-shaped screen, and the auxiliary display region including a display region on at least one side of the irregularly-shaped screen, such as a display region on the left side of the irregularly-shaped screen, or a display region on the bottom side of the irregularly-shaped screen.

In a possible implementation mode, the auxiliary display region is positioned on two sides of the screen of the terminal.

In the embodiment of the disclosure, when a notification message of a preset application is obtained, the terminal may display the notification message and the operation option nearby the preset application in the auxiliary display region. Since the auxiliary display region is different from the main display region configured to display a task interface in the terminal, if a manner of displaying the notification message in the auxiliary display region is adopted, the task interface may be prevented from being covered, and a present running task of the terminal in the main display region may also be prevented from being disturbed.

In at least one alternative embodiment, a terminal for displaying a notification message is provided, comprising: at least one processor; and a computer readable storage, coupled to the at least one processor and storing at least one computer executable instructions thereon, which when the at least one computer executable instructions is executed by the at least one processor, cause the at least one processor to carry out following actions: displaying application icons of multiple preset applications in an auxiliary display region of the terminal; determining a target application corresponding to a notification message when the notification message is obtained; and displaying the notification message and an operation option in the auxiliary display region when the multiple preset applications comprise the target application, the auxiliary display region being a region which is different from a main display region of the terminal, the main display region being configured to display an interface of a present running task of the terminal.

In at least one alternative embodiment, displaying the notification message and the operation option in the auxiliary display region of the terminal comprises at least one of following: displaying the notification message and the operation option in a preset region of the auxiliary display region; displaying the notification message and the operation option at an upper layer of an interface of a preset region of the auxiliary display region.

In at least one alternative embodiment, wherein displaying the notification message and the operation option in a preset region of the auxiliary display region comprises at least one of following:

moving the application icon of the target application to a first position in the application icons of the multiple preset applications, and displaying the notification message and the operation option in a region above the application icon of the target application;

moving the application icon of the target application to a first position in the application icons of the multiple preset applications, and displaying the notification message and the operation option in a region between the application icon of the target application and an application icon below the application icon of the target application;

moving upwards an application icon above the application icon of the target application, and displaying the notification message and the operation option in a region between the application icon of the target application and the application icon above the application icon of the target application;

moving downwards an application icon below the application icon of the target application, and displaying the notification message and the operation option in a region between the application icon of the target application and the application icon below the application icon of the target application; displaying the notification message and the operation option in a left-side region of the application icon of the target application; displaying the notification message and the operation option in a right-side region of the application icon of the target application;

moving the application icon of the target application to a first position in the application icons of the multiple preset applications, and displaying the notification message and the operation option in a region on the left side of the application icon of the target application;

moving the application icon of the target application to a first position in the application icons of the multiple preset applications, and displaying the notification message and the operation option in a region between the application icon of the target application and an application icon on the right side of the application icon of the target application;

moving left an application icon on the left side of the application icon of the target application, and displaying the notification message and the operation option in a region between the application icon of the target application and the application icon on the left side of the application icon of the target application;

moving right an application icon on the right side of the application icon of the target application, and displaying the notification message and the operation option in a region between the application icon of the target application and the application icon on the right side of the application icon of the target application;

displaying the notification message and the operation option in a region above the application icon of the target application;

displaying the notification message and the operation option in a region below the application icon of the target application.

In at least one alternative embodiment, moving the application icon of the target application to the first position in the application icons of the multiple preset applications comprises: modifying a display position of the application icon of the target application into the first position in the application icons of the multiple preset applications, and correspondingly modifying display positions of other application icons in the application icons of the multiple preset applications.

In at least one alternative embodiment, correspondingly modifying the display positions of the other application icons in the application icons of the multiple preset applications comprises one of following: modifying a display position of a first icon into an original display position of a icon which is the next icon of the first icon, the first icon being an application icon, which is displayed according to a display sequence before the application icon of the target application, in the application icons of the multiple preset applications; modifying a display position of a second icon into an original display position of the application icon of the target application, the second icon being an application icon, which is displayed in a first position according to a display sequence, in the application icons of the multiple preset applications; modifying a display position of a third icon into an original display position of a icon which is the next icon of the third icon, the third icon being an application icon, which is displayed according to a display sequence after the application icon of the target application, in the application icons of the multiple preset applications, and modifying a display position of a fourth icon into an original display position of a icon which is the next second icon of the fourth icon, the fourth icon being an application icon, which is displayed according to a display sequence before the application icon of the target application, in the application icons of the multiple preset applications.

In at least one alternative embodiment, moving upwards the application icon above the application icon of the target application comprises at least one of following: moving upwards the application icon above the application icon of the target application according to a display position of the application icon above the application icon of the target application and a preset movement distance; moving upwards the application icon above the application icon of the target application to a top of the auxiliary display region.

In at least one alternative embodiment, moving downwards the application icon below the application icon of the target application comprises at least one of following: moving downwards the application icon below the application icon of the target application according to a display position of the application icon below the application icon of the target application and a preset movement distance; moving downwards the application icon below the application icon of the target application to a bottom of the auxiliary display region.

In at least one alternative embodiment, moving left the application icon on the left side of the application icon of the target application comprises at least one of following: moving left the application icon on the left side of the application icon of the target application according to a display position of the application icon on the left side of the application icon of the target application and a preset movement distance; moving left the application icon on the left side of the application icon of the target application to a left-most side of the auxiliary display region.

In at least one alternative embodiment, moving right the application icon on the right side of the application icon of the target application comprises at least one of following: moving right the application icon on the right side of the application icon of the target application according to a display position of the application icon on the right side of the application icon of the target application and a preset movement distance; moving right the application icon on the right side of the application icon of the target application to a right-most side of the auxiliary display region.

In at least one alternative embodiment, the terminal is provided with one of following screens: a curved screen, the main display region comprising a flat display region of the curved screen, and the auxiliary display region comprising a curved display region of the curved screen; a full screen, the main display region comprising a middle display region of the full screen, and the auxiliary display region comprising a display region on at least one side of the full screen; an irregularly-shaped screen, the main display region comprising a middle display region of the irregularly-shaped screen, and the auxiliary display region comprising a display region on at least one side of the irregularly-shaped screen.

In at least one alternative embodiment, the auxiliary display region is positioned on two sides of the screen of the terminal.

In at least one alternative embodiment, a non-transitory computer-readable storage medium is provided, on which a computer program is stored, wherein the computer program is executed by a processor to carry out following actions: obtaining a notification message; and displaying the notification message and an operation option in an auxiliary display region of a terminal, the auxiliary display region being a region which is different from a main display region of the terminal, the main display region being configured to display an interface of a present running task of the terminal.

In at least one alternative embodiment, displaying the notification message and the operation option in the auxiliary display region of the terminal comprises at least one of following: displaying the notification message and the operation option in a preset region of the auxiliary display region; displaying the notification message and the operation option at an upper layer of an interface of a preset region of the auxiliary display region.

In at least one alternative embodiment, displaying the notification message and the operation option in the preset region of the auxiliary display region comprises: determining a target application corresponding to the notification message; and displaying the notification message and the operation option in the preset region, corresponding to an application icon of the target application, of the auxiliary display region, when the application icon of the target application is displayed in the auxiliary display region.

In at least one alternative embodiment, application icons of multiple preset applications are displayed in the auxiliary display region, the application icons of the multiple preset applications comprise the application icon of the target application, and displaying the notification message and the operation option in the preset region, corresponding to the application icon of the target application, of the auxiliary display region comprises at least one of following:

moving the application icon of the target application to a first position in the application icons of the multiple preset applications, and displaying the notification message and the operation option in a region above the application icon of the target application;

moving the application icon of the target application to a first position in the application icons of the multiple preset applications, and displaying the notification message and the operation option in a region between the application icon of the target application and an application icon below the application icon of the target application;

moving upwards an application icon above the application icon of the target application, and displaying the notification message and the operation option in a region between the application icon of the target application and the application icon above the application icon of the target application;

moving downwards an application icon below the application icon of the target application, and displaying the notification message and the operation option in a region between the application icon of the target application and the application icon below the application icon of the target application; displaying the notification message and the operation option in a left-side region of the application icon of the target application; displaying the notification message and the operation option in a right-side region of the application icon of the target application;

moving the application icon of the target application to a first position in the application icons of the multiple preset applications, and displaying the notification message and the operation option in a region on the left side of the application icon of the target application;

moving the application icon of the target application to a first position in the application icons of the multiple preset applications, and displaying the notification message and the operation option in a region between the application icon of the target application and an application icon on the right side of the application icon of the target application;

moving left an application icon on the left side of the application icon of the target application, and displaying the notification message and the operation option in a region between the application icon of the target application and the application icon on the left side of the application icon of the target application;

moving right an application icon on the right side of the application icon of the target application, and displaying the notification message and the operation option in a region between the application icon of the target application and the application icon on the right side of the application icon of the target application;

displaying the notification message and the operation option in a region above the application icon of the target application;

displaying the notification message and the operation option in a region below the application icon of the target application.

In at least one alternative embodiment, moving the application icon of the target application to the first position in the application icons of the multiple preset applications comprises: modifying a display position of the application icon of the target application into the first position in the application icons of the multiple preset applications, and correspondingly modifying display positions of other application icons in the application icons of the multiple preset applications.

In at least one alternative embodiment, correspondingly modifying the display positions of the other application icons in the application icons of the multiple preset applications comprises one of following: modifying a display position of a first icon into an original display position of a icon which is the next icon of the first icon, the first icon being an application icon, which is displayed according to a display sequence before the application icon of the target application, in the application icons of the multiple preset applications; modifying a display position of a second icon into an original display position of the application icon of the target application, the second icon being an application icon, which is displayed in a first position according to a display sequence, in the application icons of the multiple preset applications; modifying a display position of a third icon into an original display position of a icon which is the next icon of the third icon, the third icon being an application icon, which is displayed according to a display sequence after the application icon of the target application, in the application icons of the multiple preset applications, and modifying a display position of a fourth icon into an original display position of a icon which is the next second icon of the fourth icon, the fourth icon being an application icon, which is displayed according to a display sequence before the application icon of the target application, in the application icons of the multiple preset applications.

In at least one alternative embodiment, moving upwards the application icon above the application icon of the target application comprises at least one of following: moving upwards the application icon above the application icon of the target application according to a display position of the application icon above the application icon of the target application and a preset movement distance; moving upwards the application icon above the application icon of the target application to a top of the auxiliary display region.

In at least one alternative embodiment, moving downwards the application icon below the application icon of the target application comprises at least one of following: moving downwards the application icon below the application icon of the target application according to a display position of the application icon below the application icon of the target application and a preset movement distance; moving downwards the application icon below the application icon of the target application to a bottom of the auxiliary display region.

In at least one alternative embodiment, moving left the application icon on the left side of the application icon of the target application comprises at least one of following: moving left the application icon on the left side of the application icon of the target application according to a display position of the application icon on the left side of the application icon of the target application and a preset movement distance; moving left the application icon on the left side of the application icon of the target application to a left-most side of the auxiliary display region.

In at least one alternative embodiment, moving right the application icon on the right side of the application icon of the target application comprises at least one of following: moving right the application icon on the right side of the application icon of the target application according to a display position of the application icon on the right side of the application icon of the target application and a preset movement distance; moving right the application icon on the right side of the application icon of the target application to a right-most side of the auxiliary display region.

In at least one alternative embodiment, the terminal is provided with one of following screens: a curved screen, the main display region comprising a flat display region of the curved screen, and the auxiliary display region comprising a curved display region of the curved screen; a full screen, the main display region comprising a middle display region of the full screen, and the auxiliary display region comprising a display region on at least one side of the full screen, such as a display region on the left side of the full screen, or a display region on the bottom side of the full screen; an irregularly-shaped screen, the main display region comprising a middle display region of the irregularly-shaped screen, and the auxiliary display region comprising a display region on at least one side of the irregularly-shaped screen, such as a display region on the left side of the irregularly-shaped screen, or a display region on the bottom side of the irregularly-shaped screen.

In at least one alternative embodiment, the auxiliary display region is positioned on two sides of the screen of the terminal.

It is important to note that, when the device for displaying the notification message provided by the embodiment displays the notification message, descriptions are made with division of each of the abovementioned functional components as an example, and during practical application, the functions may be allocated to different functional modules for realization according to a requirement, that is, an internal structure of equipment is divided into different functional components to realize all or part of the functions described above. In addition, the device for displaying the notification message provided by the embodiment belongs to the same concept with the method for displaying the notification message provided by embodiment, and details about specific implementation process of the device refer to the method embodiment and will not be elaborated herein.

In an exemplary embodiment, a computer-readable storage medium storing a computer program is further provided, for example, a memory storing a computer program, and the computer program is executed by a processor to implement the method for displaying the notification message in the embodiment shown in FIG. 5 or FIG. 6. For example, the computer-readable storage medium may be a ROM, a RAM, a Compact Disc Read-Only Memory (CD-ROM), a magnetic tape, a floppy disk, optical data storage equipment and the like.

Those of ordinary skilled in the art can understand that all or part of the blocks of the embodiments may be completed by hardware and may also be completed by related hardware instructed by a program, the program may be stored in a computer-readable storage medium, and the storage medium may be a ROM, a magnetic disk, an optical disk or the like.

What is claimed is:

1. A method for displaying a notification message, comprising:
displaying application icons of multiple preset applications in an auxiliary display region of a terminal;
when a notification message is acquired, determining a target application corresponding to the notification message; and
when the multiple preset applications comprise the target application, displaying the notification message and an operation option in the auxiliary display region, the auxiliary display region being a region which is different from a main display region of the terminal, the main display region being configured to display an interface of a present running task of the terminal.

2. The method as claimed in claim 1, wherein displaying the notification message and the operation option in the auxiliary display region comprises at least one of following:
displaying the notification message and the operation option in a preset region of the auxiliary display region;
displaying the notification message and the operation option at an upper layer of an interface of a preset region of the auxiliary display region.

3. The method as claimed in claim 2, wherein displaying the notification message and the operation option in the preset region of the auxiliary display region comprises at least one of following:
moving the application icon of the target application to a first position in the application icons of the multiple preset applications, and displaying the notification message and the operation option in a region above the application icon of the target application;
moving the application icon of the target application to a first position in the application icons of the multiple preset applications, and displaying the notification message and the operation option in a region between the application icon of the target application and an application icon below the application icon of the target application;
moving upwards an application icon above the application icon of the target application, and displaying the notification message and the operation option in a region between the application icon of the target application and the application icon above the application icon of the target application;
moving downwards an application icon below the application icon of the target application, and displaying the notification message and the operation option in a region between the application icon of the target application and the application icon below the application icon of the target application;
displaying the notification message and the operation option in a left-side region of the application icon of the target application;
displaying the notification message and the operation option in a right-side region of the application icon of the target application;
moving the application icon of the target application to a first position in the application icons of the multiple preset applications, and displaying the notification message and the operation option in a region on the left side of the application icon of the target application;
moving the application icon of the target application to a first position in the application icons of the multiple preset applications, and displaying the notification message and the operation option in a region between the application icon of the target application and an application icon on the right side of the application icon of the target application;
moving left an application icon on the left side of the application icon of the target application, and displaying the notification message and the operation option in a region between the application icon of the target application and the application icon on the left side of the application icon of the target application;
moving right an application icon on the right side of the application icon of the target application, and displaying the notification message and the operation option in a region between the application icon of the target application and the application icon on the right side of the application icon of the target application;
displaying the notification message and the operation option in a region above the application icon of the target application;
displaying the notification message and the operation option in a region below the application icon of the target application.

4. The method as claimed in claim 3, wherein moving the application icon of the target application to the first position in the application icons of the multiple preset applications comprises:
modifying a display position of the application icon of the target application into the first position in the application icons of the multiple preset applications, and correspondingly modifying display positions of other application icons in the application icons of the multiple preset applications.

5. The method as claimed in claim 4, wherein correspondingly modifying the display positions of the other application icons in the application icons of the multiple preset applications comprises one of following:
modifying a display position of a first icon into an original display position of a icon which is the next icon of the first icon, the first icon being an application icon, which is displayed according to a display sequence before the application icon of the target application, in the application icons of the multiple preset applications;
modifying a display position of a second icon into an original display position of the application icon of the target application, the second icon being an application icon, which is displayed in a first position according to a display sequence, in the application icons of the multiple preset applications.

6. The method as claimed in claim 3, wherein moving upwards the application icon above the application icon of the target application comprises at least one of following:
moving upwards the application icon above the application icon of the target application according to a display position of the application icon above the application icon of the target application and a preset movement distance;
moving upwards the application icon above the application icon of the target application to a top of the auxiliary display region.

7. The method as claimed in claim 3, wherein moving downwards the application icon below the application icon of the target application comprises at least one of following:
moving downwards the application icon below the application icon of the target application according to a display position of the application icon below the application icon of the target application and a preset movement distance;
moving downwards the application icon below the application icon of the target application to a bottom of the auxiliary display region.

8. The method as claimed in claim 3, wherein moving left the application icon on the left side of the application icon of the target application comprises at least one of following:
moving left the application icon on the left side of the application icon of the target application according to a display position of the application icon on the left side of the application icon of the target application and a preset movement distance;
moving left the application icon on the left side of the application icon of the target application to a left-most side of the auxiliary display region.

9. The method as claimed in claim 3, wherein moving right the application icon on the right side of the application icon of the target application comprises at least one of following:
moving right the application icon on the right side of the application icon of the target application according to a display position of the application icon on the right side of the application icon of the target application and a preset movement distance;
moving right the application icon on the right side of the application icon of the target application to a right-most side of the auxiliary display region.

10. The method as claimed in claim 1, wherein the terminal is provided with one of following screens:
a curved screen, the main display region comprising a flat display region of the curved screen, and the auxiliary display region comprising a curved display region of the curved screen;
a full screen, the main display region comprising a middle display region of the full screen, and the auxiliary display region comprising a display region on at least one side of the full screen;
an irregularly-shaped screen, the main display region comprising a middle display region of the irregularly-shaped screen, and the auxiliary display region comprising a display region on at least one side of the irregularly-shaped screen.

11. The method as claimed in claim 1, wherein the auxiliary display region is positioned on two sides of the screen of the terminal.

12. A terminal for displaying a notification message, comprising:
at least one processor; and
a computer readable storage, coupled to the at least one processor and storing at least one computer executable instructions thereon, which when the at least one computer executable instructions is executed by the at least one processor, cause the at least one processor to carry out following actions:
displaying application icons of multiple preset applications in an auxiliary display region of the terminal;
determining a target application corresponding to a notification message when the notification message is obtained; and
displaying the notification message and an operation option in the auxiliary display region when the multiple preset applications comprise the target application, the auxiliary display region being a region which is different from a main display region of the terminal, the main display region being configured to display an interface of a present running task of the terminal.

13. The terminal as claimed in claim 12, wherein displaying the notification message and the operation option in the auxiliary display region of the terminal comprises at least one of following:
displaying the notification message and the operation option in a preset region of the auxiliary display region;
displaying the notification message and the operation option at an upper layer of an interface of a preset region of the auxiliary display region.

14. The terminal as claimed in claim 13, wherein displaying the notification message and the operation option in a preset region of the auxiliary display region comprises at least one of following:
moving the application icon of the target application to a first position in the application icons of the multiple preset applications, and displaying the notification message and the operation option in a region above the application icon of the target application;
moving the application icon of the target application to a first position in the application icons of the multiple preset applications, and displaying the notification message and the operation option in a region between the application icon of the target application and an application icon below the application icon of the target application;
moving upwards an application icon above the application icon of the target application, and displaying the notification message and the operation option in a region between the application icon of the target application and the application icon above the application icon of the target application;
moving downwards an application icon below the application icon of the target application, and displaying the notification message and the operation option in a region between the application icon of the target application and the application icon below the application icon of the target application;
displaying the notification message and the operation option in a left-side region of the application icon of the target application;
displaying the notification message and the operation option in a right-side region of the application icon of the target application;
moving the application icon of the target application to a first position in the application icons of the multiple preset applications, and displaying the notification message and the operation option in a region on the left side of the application icon of the target application;
moving the application icon of the target application to a first position in the application icons of the multiple preset applications, and displaying the notification message and the operation option in a region between the application icon of the target application and an application icon on the right side of the application icon of the target application;
moving left an application icon on the left side of the application icon of the target application, and displaying the notification message and the operation option in a region between the application icon of the target application and the application icon on the left side of the application icon of the target application;
moving right an application icon on the right side of the application icon of the target application, and displaying the notification message and the operation option in a region between the application icon of the target application and the application icon on the right side of the application icon of the target application;
displaying the notification message and the operation option in a region above the application icon of the target application;
displaying the notification message and the operation option in a region below the application icon of the target application.

15. The terminal as claimed in claim 14, wherein moving the application icon of the target application to the first position in the application icons of the multiple preset applications comprises:
modifying a display position of the application icon of the target application into the first position in the application icons of the multiple preset applications, and correspondingly modifying display positions of other application icons in the application icons of the multiple preset applications.

16. The method as claimed in claim 15, wherein correspondingly modifying the display positions of the other application icons in the application icons of the multiple preset applications comprises one of following:
modifying a display position of a first icon into an original display position of a icon which is the next icon of the first icon, the first icon being an application icon, which is displayed according to a display sequence before the application icon of the target application, in the application icons of the multiple preset applications;
modifying a display position of a second icon into an original display position of the application icon of the target application, the second icon being an application icon, which is displayed in a first position according to a display sequence, in the application icons of the multiple preset applications.

17. A non-transitory computer-readable storage medium, on which a computer program is stored, wherein the computer program is executed by a processor to carry out following actions:
obtaining a notification message; and
displaying the notification message and an operation option in an auxiliary display region of a terminal, the auxiliary display region being a region which is different from a main display region of the terminal, the main display region being configured to display an interface of a present running task of the terminal.

18. The non-transitory computer-readable storage medium as claimed in claim 17, wherein displaying the notification message and the operation option in the auxiliary display region of the terminal comprises at least one of following:
displaying the notification message and the operation option in a preset region of the auxiliary display region;
displaying the notification message and the operation option at an upper layer of an interface of a preset region of the auxiliary display region.

19. The non-transitory computer-readable storage medium as claimed in claim 18, wherein displaying the notification message and the operation option in the preset region of the auxiliary display region comprises:
determining a target application corresponding to the notification message; and
displaying the notification message and the operation option in the preset region, corresponding to an application icon of the target application, of the auxiliary display region, when the application icon of the target application is displayed in the auxiliary display region.

20. The non-transitory computer-readable storage medium as claimed in claim 19, wherein application icons of multiple preset applications are displayed in the auxiliary display region, the application icons of the multiple preset applications comprise the application icon of the target application, and displaying the notification message and the operation option in the preset region, corresponding to the application icon of the target application, of the auxiliary display region comprises at least one of following:
moving the application icon of the target application to a first position in the application icons of the multiple preset applications, and displaying the notification message and the operation option in a region above the application icon of the target application;
moving the application icon of the target application to a first position in the application icons of the multiple preset applications, and displaying the notification message and the operation option in a region between the application icon of the target application and an application icon below the application icon of the target application;
moving upwards an application icon above the application icon of the target application, and displaying the notification message and the operation option in a region between the application icon of the target application and the application icon above the application icon of the target application;
moving downwards an application icon below the application icon of the target application, and displaying the notification message and the operation option in a region between the application icon of the target application and the application icon below the application icon of the target application;
displaying the notification message and the operation option in a left-side region of the application icon of the target application;
displaying the notification message and the operation option in a right-side region of the application icon of the target application;
moving the application icon of the target application to a first position in the application icons of the multiple preset applications, and displaying the notification message and the operation option in a region on the left side of the application icon of the target application;
moving the application icon of the target application to a first position in the application icons of the multiple preset applications, and displaying the notification message and the operation option in a region between the application icon of the target application and an application icon on the right side of the application icon of the target application;
moving left an application icon on the left side of the application icon of the target application, and displaying the notification message and the operation option in a region between the application icon of the target application and the application icon on the left side of the application icon of the target application;
moving right an application icon on the right side of the application icon of the target application, and displaying the notification message and the operation option in a region between the application icon of the target application and the application icon on the right side of the application icon of the target application;
displaying the notification message and the operation option in a region above the application icon of the target application;
displaying the notification message and the operation option in a region below the application icon of the target application.
